(19) United States
(12) Patent Application Publication
(10) Pub. No.: US 2005/0154594 A1
(43) Pub. Date: Jul. 14, 2005

(54) Method and apparatus of simulating and stimulating human speech and teaching humans how to talk

(76) Inventor: Stephen C. Beck, Berkeley, CA (US)

Correspondence Address: BIRCH STEWART KOLASCH & BIRCH, PO BOX 747, FALLS CHURCH, VA, 22040-0747, US

(21) Appl. No.: 10/754,774

(22) Filed: Jan. 9, 2004

(51) Int. Cl. G10L 11/00

(52) U.S. Cl. 704/276

(57) ABSTRACT

This invention comprises a method and apparatus for combining electronic voice recognition circuits, electronic voice synthesis circuits, electronic computational artificial intelligence algorithms and computer programs in an interactive learning process, so as to simulate the experience of learning to talk, speak words, phrases, and sentences, and other types of human speech. The invention may be embodied in a number of specific forms, ranging from voice and audio systems and experiences operating over communications systems or as entertainment and educational experiences operating on personal computers, video game systems, portable computing machines, and the like. The invention may also be embodied in self-contained, portable electronic toys and games, including, but necessarily limited to, dolls, plush animals, creatures or character figures and sculptures.

This-application claims priority of U.S. Provisional Patent Application Ser. No. 60/305,03 1, filed Jul. 12, 2001, which in its entirety is incorporated by reference herein, and PCT Application, Ser. PCT/US02/22362, filed Jul. 12, 2002, which in its entirety is incorporated by reference herein.

### FIELD OF THE INVENTION

This invention relates generally to electronic entertainment and education systems, such as toys, video and computer games, and telephonic subscription services.

### BACKGROUND

Inventions with electronic voice recognition capabilities have been around for several years. One example being the airline company telephone numbers which will provide a caller with flight arrival information, based on voice responses by the caller on the telephone.

Likewise, many products and services, toys and games have employed electronic voice synthesis for many years. Talking dolls, automated voice response telephone systems such as voice mail, stock price reporting, sports scores, and the like.

Some of these systems use pure electronic voice synthesizers to generate phonemes, words and phrases from a dictionary of core sound fragments. Other systems use actual human voices recorded as certain words and phrases, which are stored in a digital form in a computer memory.

Depending on the situation and actions, a control program running on a digital computing device will assemble the word elements, voice elements, phrase and other parts into complete sentences, and present them in audio form to a human listener by means of a digital to analog converter circuit, connected directly or indirectly to an audio reproduction device such as a loud speaker, and audio headphone set, or via the telephone receiver.

Likewise, numerous applications of so called “artificial intelligence” have been developed by means of custom software programs operating on electronic digital computing devices. The range of prior art in this field is quite large, and encompasses man, many topics, ranging from analyzing raw data from geological field measurements so as to determine likely locations to drill for oil, for example, to use in financial models and stock trading decisions by Wall Street companies.

Talking toys are not unique. There are many talking toys as shown by the number of talking dolls, vehicles, puppets, inanimate objects, and animals now available. These talking toys, however, say the same preprogrammed sounds, words, phrases, or sentences, although the order in which they are spoken may vary.

Furby toys by Tiger Electronics, Ltd. is an example of a talking toy. It generally, however, speaks Furbish (Furby language). After a certain amount of playtime—for example, rubbing its tummy, covering its eyes, and patting its back—it starts speaking English. It does not, however, learn or simulate the learning of English, similar to how infants and toddlers learn to speak a language.

The applicant is not aware of any toy that seemingly learns to speak a language. A toy that learns how to speak words and eventually sentences would be interesting to children and to some adults. It may also be used for educational purposes such as teaching toddlers how to say words and phrases.

From the foregoing discussion, important aspects of the technology used in the field of the invention remain amenable to useful refinement.

### SUMMARY OF THE DISCLOSURE

The present invention introduces such refinement. In its preferred embodiments, the present invention has several aspects or facets that can be used independently, although they are preferably employed together to optimize their benefits.

In preferred embodiments of a first of its facets or aspects, the invention is a children's play method for creating the appearance of teaching a toy character to progressively learn a language. This method includes the step of defining a target word. It also includes the step of receiving by the toy character the target word zero or more times over a first period of time. Another step is speaking and/or displaying by the toy character during the first time period of one or more protowords related to the toy character but not to the target word. Yet another step is then receiving by the toy character the target word zero or more times over a second period of time.

Still another step is speaking and/or displaying by the toy character during the second time period of one or more metawords related to the target word, or a combination of one or more such protowords and one or more such metawords. Still a further step is then receiving by the toy character the target word zero or more times over a third period of time.

A still further step is speaking and/or displaying by the toy character during the third time period of one or more target words. Alternatives to this include: speaking and/or displaying a combination of one or more target words and one or more such metawords, or a combination of one or more target words and one or more such protowords, or a combination of one or more target words and one or more such protowords and one or more such metawords.

The foregoing may represent a description or definition of the first aspect or facet of the invention in its broadest or most general form. Even as couched in these broad terms, however, it can be seen that this facet of the invention importantly advances the art.

In particular, this facet of the invention enables a toy to very realistically take on the appearance of progressive speech learning in humans. This aspect of the invention provides progression in generally three stages. A toy character initially speaks or displays protowords—words and/or sounds related to the character but not to the word.

As it progresses it starts to utter metawords—words and/or sounds related to the word. It generally ultimately speaks or displays the target word. This simulation is typically entertaining to children and may be even used for educational purposes.

This facet of the invention also provides simulated progressive speech learning embodied in various forms. This facet may be embodied, for example, in software programs running on computers, codes running on microcontrollers, firmware devices, hardware devices, or in any computing unit that performs instructions.

Furthermore, the benefits of this facet may be enjoyed from tangible three-dimensional, virtual visual, and/or virtual form toys. Although the first major aspect of the invention thus significantly advances the art, nevertheless to optimize enjoyment of its benefits preferably the invention is practiced in conjunction with certain additional features or characteristics as discussed in following sections of this document.

In preferred embodiments of its second major independent facet or aspect, the invention is a program product for use in a computer system that executes program steps to perform a method of simulated speech learning by a toy character. These program steps are recorded in one or more computer-readable media.

The program product includes one or more computer-readable media. It also includes a program of computer-readable instructions that may be executed by a computer to perform a method. This program consists of one or more program components stored in one or more computer-readable media.

The method includes the step of defining a target word. It also includes the step of receiving by the toy character the target word zero or more times over a first period of time.

Another step is speaking and/or displaying by the toy character, during the first time period, of one or more protowords related to the toy character but not to the target word. Yet another step is then receiving by the toy character the target word zero or more times over a second period of time. Still another step is speaking and/or displaying, by the toy character, during the second time period, of one or more metawords related to the target word, or a combination of one or more such protowords and one or more such metawords. Still a further step is then receiving by the toy character the target word zero or more times over a third period of time.

Still another step is speaking and/or displaying by the toy character during the third time period of one or more target words, or a combination of one or more target words and one or more such metawords, or a combination of one or more target words and one or more such protowords, or a combination of one or more target words and one or more such protowords and one or more such metawords.

The foregoing may represent a description or definition of the second aspect or facet of the invention in its broadest or most general form. Even as couched in these broad terms, however, it can be seen that this facet of the invention importantly advances the art.

In particular, this facet specifically facilitates enjoyment of the learning-simulation entertainment and educational properties of the first aspect of the invention—but now expressly without need for a physically holdable, three-dimensional doll or like toy. Thus this aspect of the invention makes those properties available in program products as such.

They may be packaged, for example, as software in CD-ROMs or floppy disks, and executed on appropriate computing devices. Some now-available hand-held devices may also use such program products, thereby enabling portable entertainment for children.

This facet of the invention also provides for embodiments that are electronically accessed by consumers. Such program product, for example, may be downloaded from the Internet, accessed and run via the Internet or other data networks (e.g. server-side processing using a local area network or the Internet), stored in external computer-readable media, and the like.

This aspect of the invention thus makes available, in addition to portable entertainment, a more-flexible sort of access to the learning-simulation effects discussed above. Although the second major aspect of the invention thus significantly advances the art, nevertheless to optimize enjoyment of its benefits preferably the invention is practiced in conjunction with certain additional features or characteristics—including incorporation of the other independent aspects of the invention, and some of their respective preferences.

In preferred embodiments of its third major independent facet or aspect, the invention is a device for simulated speech learning by a toy character. This device includes a central processing unit and a program memory, which stores the programming instructions that are executed by the central processing unit such that a method is performed.

The method includes the step of defining a target word. It also includes the step of receiving by the toy character the target word zero or more times over a first period of time.

Another step is speaking and/or displaying by the toy character during the first time period of one or more protowords related to the toy character but not to the target word. Yet another step is then receiving by the toy character the target word zero or more times over a second period of time.

Still another step is speaking and/or displaying by the toy character during the second time period of one or more metawords related to the target word, or a combination of one or more such protowords and one or more such metawords. Still a further step is then receiving by the toy character the target word zero or more times over a third period of time.

Still another step is speaking and/or displaying by the toy character during the third time period of one or more target words, or a combination of one or more target words and one or more such metawords, or a combination of one or more target words and one or more such protowords, or a combination of one or more target words and one or more such protowords and one or more such metawords.

The foregoing may represent a description or definition of the third aspect or facet of the invention in its broadest or most general form. Even as couched in these broad terms, however, it can be seen that this facet of the invention importantly advances the art.

In particular, this facet provides implementation of the novel advantages of the invention not only in the form of packaged programmed elements as such (CD-ROMs for instance) as above, but also for operating programmed devices, such as microcontrollers and chips. In this way the same tutorial and recreational benefits discussed above can also be made available in the form of commercial, off-the-shelf operating hardware—ready to install into any number of entirely diverse external packagings.

Thus this aspect of the invention contemplates and facilitates implementation in extremely cost-effective ways, ways that accommodate conventional industrial practice. For instance chip manufacturers can focus upon making the basic operating hardware, while toy manufacturers can handle the manufacture and/or assembly of tangible and seemingly teachable toys.

Although the third major aspect of the invention thus significantly advances the art, nevertheless to optimize enjoyment of its benefits preferably the invention is practiced in conjunction with certain additional features or characteristics. Some such added elements are discussed in following sections of this document; some entail practice of this facet of the invention in combination together with other independent aspects.

In preferred embodiments of its fourth major independent facet or aspect, the invention is a play method for creating the appearance that a toy character is learning to speak. This method includes the step of providing the toy character with a target word.

It also includes the step of providing the toy character with potential outputs. The outputs include the following which are arranged in order from lower to higher level: outputs that include one or more protowords related to the toy character but not to the target word; outputs that include one or more metawords related to the target word; and outputs that include one or more repetitions of the target word.

The method further includes the step of providing the toy character with potential learning levels that correspond to the potential output levels. Another step is sequentially increasing and updating the learning level to an active one based on one or more predetermined criteria.

Still another step is providing active output from the toy character of one or more of the potential outputs based on the active learning level. The available output at any active learning level being only the potential output associated with that active learning level and any lower potential outputs, but not any higher potential outputs.

The foregoing may represent a description or definition of the fourth aspect or facet of the invention in its broadest or most general form. Even as couched in these broad terms, however, it can be seen that this facet of the invention importantly advances the art.

In particular, by providing for simulated speech learning based on a principle of active learning level, this facet of the invention enables toy manufacturers, programmers, chip makers, and the like to create a variety of toys that simulate speech learning in a number of different ways (e.g. a set of toys learn faster if hugged a certain number of times, if tickled a certain number of times, and/or if spoken to more often).

In this way, the population of seemingly teachable toys may be made extremely diverse—analogously to the ways in which humans are different from each other. Although the fourth major aspect of the invention thus significantly advances the art, nevertheless to optimize enjoyment of its benefits preferably the invention is practiced in conjunction with certain additional features or characteristics as discussed in other sections of this document.

In preferred embodiments of its fifth major independent facet or aspect, the invention is a method of simulated progressive speech learning by a toy character. The method includes the step of storing a dictionary of words, and other speech forms if desired. This dictionary includes one or more protowords and one or more target words.

The method also includes the step of setting an initial learning-level information. Another step is receiving a word, the word being a target word found in the dictionary.

Also another step is recognizing the received word. Yet another step is retrieving the learning-level information for the received word. Still another step is generating an output based on the retrieved learning-level information.

The foregoing may represent a description or definition of the fifth aspect or facet of the invention in its broadest or most general form. Even as couched in these broad terms, however, it can be seen that this facet of the invention importantly advances the art.

In particular, this facet provides a very simple and easy methodology for achieving the same benefits and advantages as the first and fourth facets discussed above—but in particular without having to incorporate the target, meta- and protowords into the device programming as such. Instead the necessary linguistics are reserved into a separate plain-text database or configuration file that is nearly transparent to writing or operation of the program.

Among other powerful benefits of establishing the procedure in this way is that the programming itself can be made universal as to the languages of different cultures and even different nations: only the dictionary file(s) need be changed to move from English to Chinese, Swahili, Arabic or Thai.

Although the fifth major aspect of the invention thus significantly advances the art, nevertheless to optimize enjoyment of its benefits preferably the invention is practiced in conjunction with certain additional features or characteristics as discussed in following sections of this document.

In preferred embodiments of its sixth major aspect or facet, the invention is a method for causing a toy character to appear to learn target speech—which is to say, speech which is or includes one or more target words. The method includes the step, performed by the toy character, of speaking or displaying protospeech—again, speech which is or includes one or more protowords.

Thus “protospeech” means one or more words or sounds which are generally associated with the toy character—but generally not associated with the target speech. For example, if the target speech is “Hug me, Mama,” and the toy character is configured to appear as a baby, protospeech might be simply babylike whimpering or burbling sounds.

The word “generally” used above is intended to encompass exceptions, from time to time, for two very different reasons. First, the seeming behavior of the toy is thereby given a more-realistic personality; and second, certain of the appended claims cannot be circumvented merely by introducing exceptions in the programming of the toy character, etc.

Thus for example the protospeech may sometimes or occasionally have no evident connection with the toy character; and occasionally may seem to have some connection with the target speech. For instance, continuing the example initiated above, protospeech might be “Hmm!”—enunciated in a not-distinctly babylike way. On the other hand, protospeech might instead be “Muh. Mehh. Meeeeahh,” or even “Me!”—which do have some connection with the target speech.

Thus although ideally the very beginning of the sequence is associated with the character and not the target, this is only a most-ideal or most-pure case. Strict conformance with this ideal is expressly waived by the term “generally”.

The method further includes the step, also performed by the toy character, of responding by first waiting for at least one predetermined event, and then speaking or displaying other speech that is generally along a progression from the protospeech toward the target speech. (In other parts of this document, such “other speech” is denominated as one or more “metawords”. Note that the concepts of other speech and also target speech encompass assemblages of words that include speech other than target words and metawords.)

The foregoing may represent a definition or description of the sixth main facet of the invention in its most-general or broad form; however, even as thus broadly set forth this aspect of the invention can be seen to move the art forward in a very important and beneficial way.

In particular, this facet of the invention imparts to the toy character a remarkably lifelike behavior, and in fact captures poignant elements of a living human's or other creature's personality. Such behavior and personality emulate precisely the element that is missing from the “Furby” line, and from all other known toys such as discussed in the earlier “Background” section—namely, that very naturalness in the way toddlers and infants learn language progressively.

Nevertheless, despite the valued refinements in the art provided by the sixth facet of the invention as most-broadly set forth above, the invention is preferably practiced in conjunction with certain other characteristics and features that greatly enhance those refinements. For instance, it is very highly preferred that the method further include iterating the responding step—in other words, again waiting for a predetermined event (not necessarily the same event as in the first, base method), and then again speaking or displaying protospeech that is generally further along the progression toward the desired, target speech.

This invention contemplates that eventually the toy may speak or display the target speech perfectly. That eventual result, however, is not required by the description or definition of this sixth aspect of the invention as set forth to this point.

Another preference is that the method also includes the step of providing the target speech to the toy character, before the speaking or displaying step. This providing step is simply a precursor to the basic method as set forth above; and is typically performed by a human, or by some other entity—as, for example, another toy character—or may be effectuated by preprogramming into the toy character itself.

Another preference is that the providing step includes one or more of these modes of providing:

speaking the target speech to the toy character;

inputting the target speech on a keypad; and

selecting the target speech from a displayed list.

In regard to this last-mentioned mode, it is still more preferable that the selecting step entails use of such a list that is displayed by the toy character itself.

Also preferably, the predetermined event includes one or more of these occurrences:
passage of a specified time;
again providing the target speech to the toy character;
physical manipulation of the toy character; and
other occurrences sensed by the toy character.

Still another important preference is in actuality a pair of alternative preferences: in one of these, the progression is substantially monotonic in advancing from the protospeech toward the target speech. Thus the toy character appears to learn responsively—or, to put it in another way, to be a very, very good learner.

(Here the term “monotonic” is used in its conventional mathematical sense. In that meaning, a monotonic function is one that—in essence—always proceeds consistently in one direction or another, never reversing.)

In the alternative, the progression is substantially not monotonic in advancing from the protospeech toward the target speech. Here, as suggested earlier, the toy character appears to sometimes forget what has been previously learned—and perhaps thereby to attain to a very sympathetic sort of humanlike personality.

When this particular preference is observed, then it is further preferable that the advancement of the toy along the progression from protospeech to target speech be generally statistical. This means that in the programming of the processor that implements the invention, statistical or pseudostatistical processes are used to determine how the toy will act—in each round or cycle of behavior in the progression. By “statistical or pseudostatistical” it is meant that the program actually selects the next position along the progression by finding or generating a random, randomized or pseudorandom number and using that number in the selection process.

The present invention also combines voice recognition, voice production and computational capabilities so as to result in the apparent or simulation of teaching an entity how to talk, how to learn to talk, and also receiving unexpected results from the developing apparent intelligence so imbued into said entity.

By clever use of voice recognition, either speaker dependent or speaker independent, and either using a finite dictionary of learnable words, phrases, even musical song notes, combined with clever programming of the learning algorithms of a stored computing program, then combined with high quality electronic speech and sound synthesis, using voices in any number of languages, genders, ages, personalities, and the like, amusing, novel, entertaining, and even educational results will occur.

The detailed description which follows describes a number of embodiments of the invention, including flowcharts and algorithms for the learning process, use of metawords and metaphases in the speech process to simulate the gradual learning of the words, and implementations in many various systems ranging from simple, low cost toys and games, to modestly cost level programs which run on personal computers or home video game systems, to large scale, multi-user systems operating via the telephone network system which require substantial computing power and memory, as well as telephone line multiplexes and financial billing systems.

All of the foregoing operational principles and advantages of the present invention will be more fully appreciated upon consideration of the following detailed description, with reference to the appended drawing, of which:

### BRIEF DESCRIPTION OF THE DRAWINGS

FIG. 1 is a conceptual elevation of one preferred embodiment of a seemingly teachable three-dimensional tangible talking toy, partly cut away to show a block diagram of components present in a learning unit, in accordance with a preferred embodiment of the invention;

FIG. 2A is a basic block diagram of an exemplary general progression of learning, including learning progression for target words teachable to a teachable toy, in accordance with the invention;

FIG. 2B is a block diagram of an exemplary controlling unit of the FIG. 1 teachable toy;

FIG. 3 is a like view of FIG. 1 but showing exemplary locations of devices, such as input units, output units, and switches;

FIGS. 4A and 4B are exemplary headsets that may be used with the FIG. 1 teachable toy;

FIG. 5 is a representative diagram of basic operations to seemingly teach the FIG. 1 teachable toy to learn a target word, in accordance with a preferred embodiment of the invention;

FIG. 6 is an exemplary block diagram of memory space implementing the progression of learning levels of the FIG. 1 teachable toy, in accordance with a preferred embodiment of the invention;

FIG. 7 is a representative diagram of exemplary basic operations, with more details, to seemingly teach the FIG. 1 toy to learn a word, in accordance with a preferred embodiment of the invention;

FIGS. 8 and 9 are high-level block diagrams of speech processing chips supporting voice recognition and speech synthesis, in accordance with the invention;

FIG. 10 is a block diagram of the exemplary speech processing chips of FIGS. 8 and 9, but in more detail;

FIG. 11 is a like view of FIG. 1, but showing a printed circuit board with a FIG. 9 speech-processing chip;

FIG. 12 is a high-level block diagram of a speech processing chip of FIGS. 8 and 9, but showing data paths;

FIG. 13 is a virtual audio and visual system supporting a virtual visual and/or audio toy, in accordance with a preferred embodiment of the invention;

FIG. 14 is a hand-held device supporting a virtual visual and/or audio toy, in accordance with a preferred embodiment of the invention;

FIG. 15 is a like view of FIG. 14, but with a wireless input and output device;

FIG. 16 is a block diagram of an exemplary controlling unit of a virtual visual and/or audio teachable toy;

FIG. 17 is a virtual audio system supporting a virtual audio toy, in accordance with a preferred embodiment of the invention;

FIG. 18 is a high-level block diagram of the databases or files used by the FIG. 17 virtual audio system; and

FIG. 19 is a basic block diagram of a computer supporting the FIG. 13 and/or FIG. 17 systems, in accordance with a preferred embodiment of the invention.

### DETAILED DESCRIPTION OF PREFERRED EMBODIMENTS

Tangible/Tactile Three-Dimensional (3D) Teachable Toy

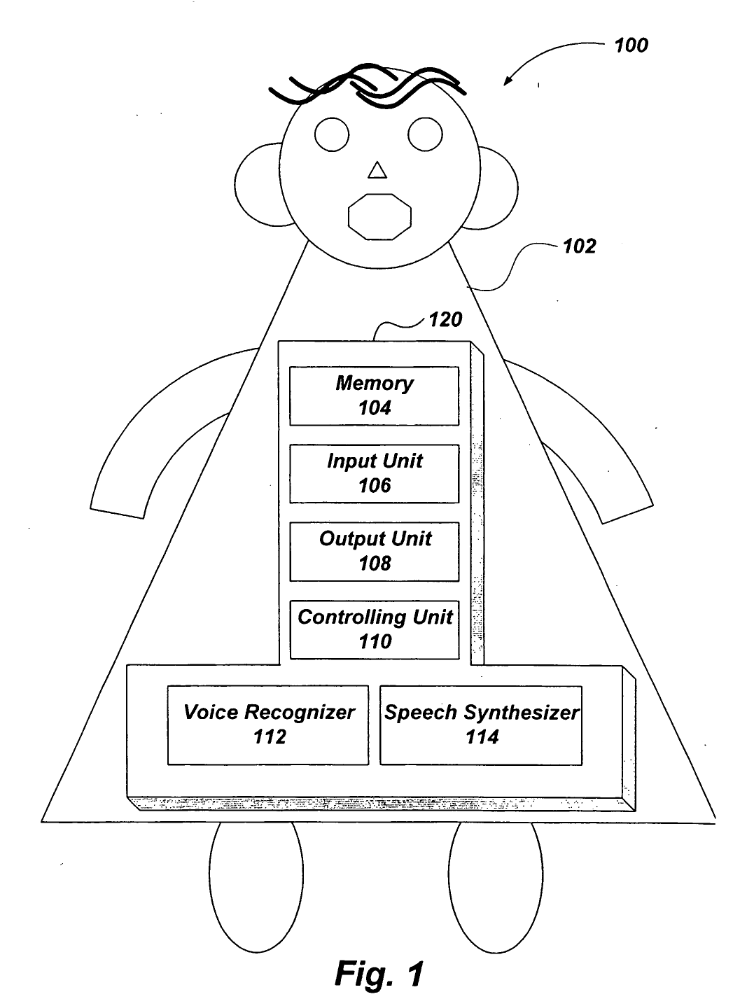

A seemingly teachable and seemingly learning tangible or tactile three-dimensional (3D) talking toy 100 (FIG. 1) of one preferred embodiment includes a toy 102 (e.g. a doll) and a learning unit 120. It is tangible in that it may be touched and held by a user, such as a child, and is in three-dimensional form. The learning unit 102 typically comprises a memory or a data storage 104, an input unit 106, an output unit 108, a controlling unit 110, a voice recognizer 112, and a speech synthesizer 114.

Toys as used herein include entities embodied in tangible/tactile physical forms and those that are in virtual form. A virtual-form toy as defined herein is an audio and/or visual representation of an entity.

Virtual visual toys are generally visually presented in two-dimension, but may also be presented in three-dimension. Toys may be embodied in various forms such as in an animal, an inanimate object, a doll, a plant, a robot, an alien being, or a space creature. An example of a virtual visual and/or audio toy is a character in a video software game—e.g. a cartoon character, a kitty cat in a pet training game, a character in a role-playing game, etc.

A toy 102 (FIG. 1), in this embodiment, is any tangible three-dimensional entity, such as a doll, an animal character, an alien character, an inanimate object (e.g. lamp, desk, robot, and toaster), or a plant. It may be made in various sizes and of various materials such as plastic, plush fabrics, metal, or porcelain

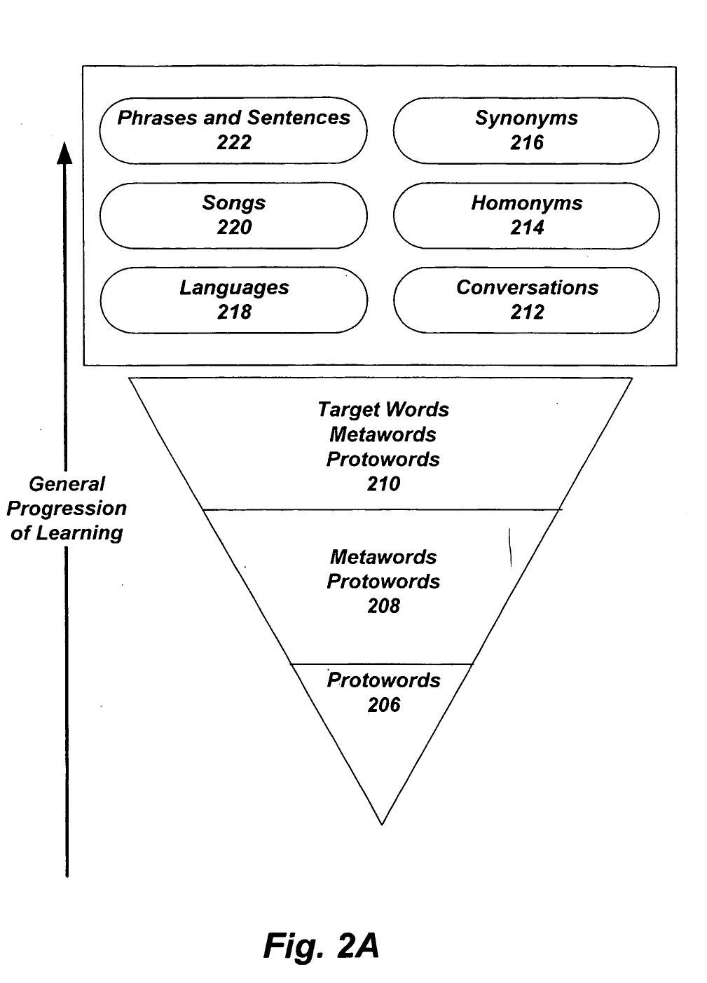

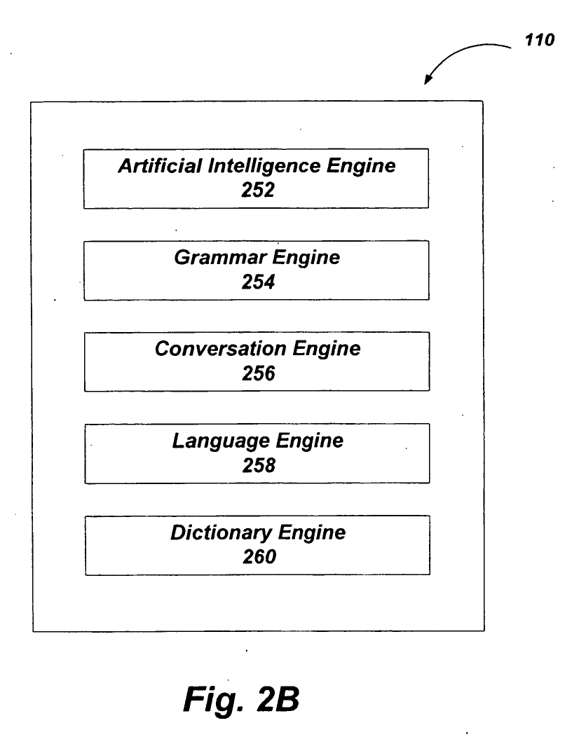

Using electronic voice recognition technologies 112 together with electronic sound synthesis and generation technologies 114 available in the open marketplace, combined with control algorithms 110, which implement one or more engines (FIG. 2B), the teachable toy 100 (FIG. 1) of the present invention simulates the learning of speech and languages (words, phrases, and sentences). The 3D-talking toy 100 may also be seemingly taught to sing, hum, or make other musical behaviors, such as learning to sing simple songs and folk tunes.

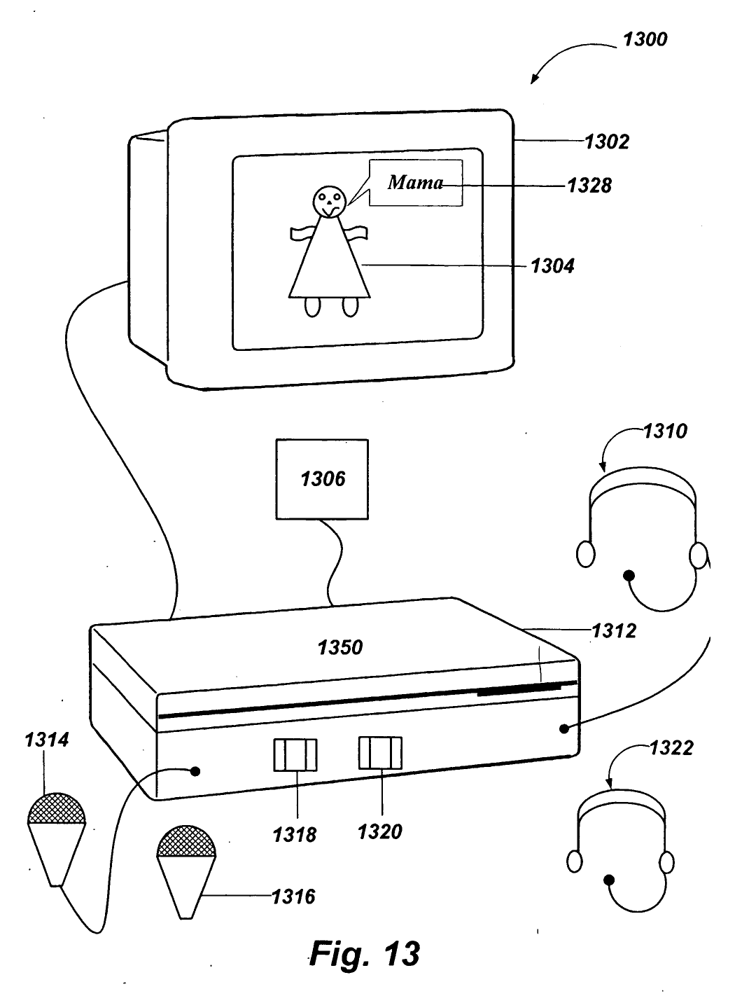

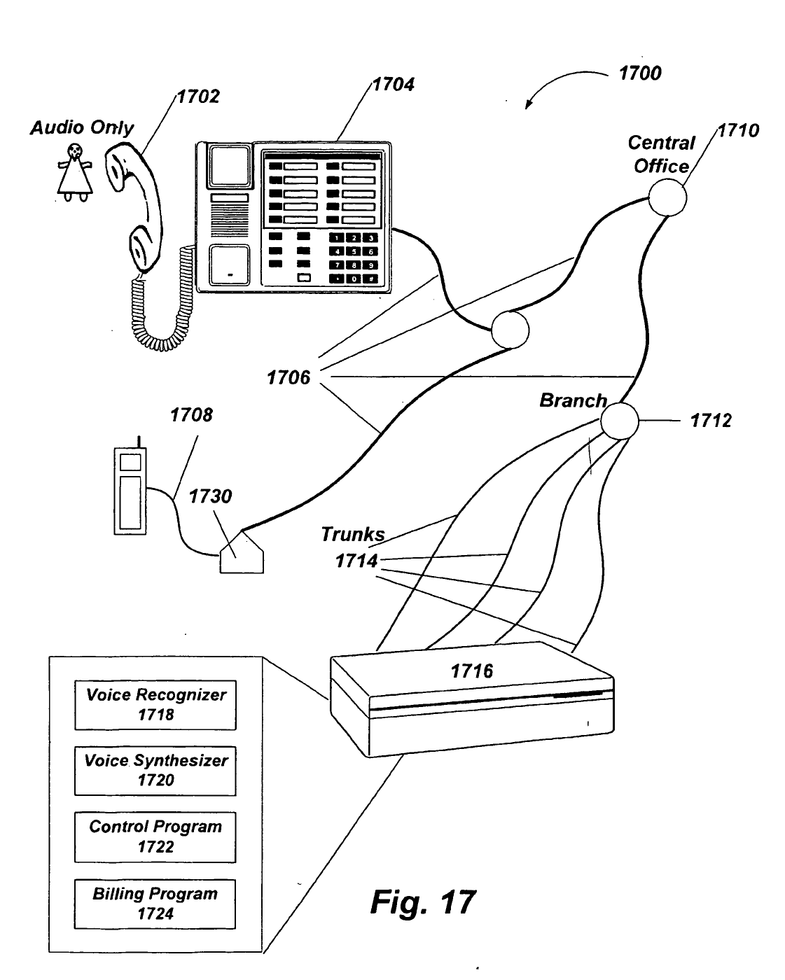

The various embodiments of the present invention (e.g. 3D tangible teachable toy (3D teachable toy) (FIGS. 1, 3, and 11), virtual audio and/or visual teachable toy (FIGS. 13 through 15), and virtual audio teachable toy (FIG. 17)) simulate the learning of speech, because these teachable toys do not and are not capable of learning a language the same way human beings (or even talking birds like parrots) learn how to talk, sing, and understand a language. Considering also that they are not capable of actually learning in the same way that human beings do, in general they are only seemingly teachable, i.e. capable only of simulated speech learning.

A teachable toy 100 has its own original native sounds or words, called protowords. Protowords are basic or natural words and/or sounds related to the toy character. These protowords are preferably stored in a memory 104.

The protowords for each teachable toy 100 preferably depend on the form of the toy 102. If the toy 102 is a parrot, the protowords include variations of squawking sounds.

If the toy is a lamp, made-up sounds may be its protowords. If the toy is a baby doll, its protowords preferably include cooing, babbling, gurgling, squealing noises, and the like.

A 3D teachable toy 100 (FIG. 1) may be “taught” to learn certain words called target words. These target words are preferably stored in a memory 104 and are included in the dictionary of the teachable toy 100.

The number of target words typically depends on toy design and implementation. The teachable toy 100 may learn all the words in its dictionary.

There is a general progression of learning (FIG. 2A). This progression is also generally dependent on product design and play pattern. At its original or natural condition, a teachable toy utters only protowords. Similar to human beings, it learns (target) words by being taught. A target word is preferably categorized in a hierarchy.

At the lowest level, the target word is not learned. In this level, only protowords 206 are uttered. A word is preferably deemed not learned (unlearned) when the user/teacher of the teachable toy (e.g. a child) has never spoken the word to the toy and the teachable toy has never recognized this target word. Other predetermined conditions or criteria (which include those created or defined by the manufacturer as well as those created, defined or adjusted by the child-user) for being not learned may also be used such as if amount of playing time with teachable toy is less than five minutes or if a switch is set to no-learning mode.

At the next level higher, a target word is generally partially learned. A target word is partially learned when another predetermined criteria or condition (including one that is user defined or adjusted) is met, such as when the voice recognizer 112 (FIG. 1) of the teachable toy 100 has recognized the target word, preferably at least once.

At this level, metawords 208 (FIG. 2) of the target word are uttered. Metawords are words and/or sounds related to the target word.

When a teachable toy has reached a certain level of learning, it may be designed to also utter lower-level sounds and/or words. Thus, optionally, when the teachable toy reaches the higher level to utter metawords 208, lower level protowords may also be uttered.

Metawords are further discussed below. At the next highest level, when yet another predetermined criteria is achieved, a target word 210 is filly learned.

At this level, the teachable toy correctly speaks the target word. Optionally, metawords and/or protowords too may be uttered at this level. A teachable toy simulates learning because it initially only says protowords, progresses to saying metawords, until it eventually correctly says the target word.

As stated above, a metaword is a word and/or sound related to a target word. It is preferably a combination of one or more protowords (or portions thereof) and the target word (or portions thereof). The resulting blended or morphed metaword may be designed to be amusing, funny, and interesting to lend credibility to the simulation of speech learning.

Metawords are preferably stored into the memory 104 (FIG. 1). In this embodiment, the metaword is predetermined and only synthesized at run time. In an alternative embodiment, metawords are both determined and synthesized at run-time by the controlling unit 110, particularly the artificial intelligence engine 252 (FIG. 2B). This means that the metaword is not predetermined and is algorithmically determined at run time.

Protowords and metawords may also consist of and include mispronunciations. They can include malapropisms, transposing word syllables, mixing up two words in combinations (for phrases and sentences), and so forth. In one embodiment, the 3D teachable toy 100 also, after meeting further predetermined or user-defined criteria, learns how to speak target phrases and sentences.

These target phrases and sentences may be tailored to be humorous, surprising, startling, and entertaining to hear. Target phrases and sentences are hereinafter collectively referred to as target sentences.

Similar to target words, the conditions or criteria of when and what target sentences are to be spoken depend on product design. Target sentences may also have their own hierarchy. The 3D teachable toy 100 may be designed to speak target sentences by concatenating only fully learned target words.

It may be designed to speak target sentences combining fully learned target words and metawords of other target words. It may also be designed that it only says target sentences after some point in time—such as after the teachable toy has experienced a sufficient amount of stimulation or playtime.

The target sentences spoken may be based on a pool of sentences already spoken to it by the user. In another embodiment, if the controlling unit 110 of the teachable toy includes a dictionary and/or thesaurus engine 210 (FIG. 2B), the teachable toy may say sentences even using words never learned.

The target sentences may also be designed to be always grammatically correct, typically by using a grammar engine 254. Deviations from grammatically correct sentences may be allowed for amusement and “cuteness” effects. The grammar engine may also be designed to initially allow grammatically incorrect sentences and then have those sentences evolve into grammatically correct versions later.

Features of homonyms 214 (FIG. 2A), synonyms 216, and languages 218 may also be uttered by the teachable toy. They are further discussed below. Teachable toys may also simulate carrying on an apparently intelligent conversation 212. This feature is also further discussed below.

Songs 218 may also be learned by a teachable toy. When such songs may be learned depends on product design. The teachable toy may be able to hum tunes even by just using protowords and/or metawords. In another embodiment, songs are sung using fully learned target words, protowords, and/or metawords.

Other variations of progressive learning may also be incorporated in the teachable toy. For example, as the teachable toy matures in learning, it better enunciates words, its learning level increases faster as compared to earlier sessions (e.g. if before a target word is fully learned after being heard twenty times, the teachable toy now fully learns a word after being heard only ten times), it utters more sophisticated target sentences, and the like.

A teachable toy may also be designed to have some behavior patterns, which may depend on various predetermined criteria such as time of day, amount of playing time, and sensor readings. For example, at a certain time of day, a teachable toy may be perky and playful and yet at another time of day, be sleepy. This may be shown by the metawords, protowords, and/or target words uttered, the manner of speaking (e.g. speaks slower at around naptime), and the amount of giggling and laughing.

The 3D teachable toy 100 (FIG. 1) may also include “animatronic” features—i.e. movements of the toy, typically controlled by electric or pneumatic motors. In this embodiment, the mouth, eyes, hands, arms, tails, etc. may be made to move.

The movements may also be coordinated with what is being uttered by the talking toy 100. For example, if a teachable toy doll says “Baby wants milk,” a speech-and-motor coordination engine controls the teachable doll 100 so that when this phrase is spoken, the teachable doll also accordingly, for example, moves one of her hands to her lips to indicate thirst.

Table I below shows exemplary protowords, target words, metawords (based on the target word “mama”), and target sentences of a 3D teachable toy 100 embodied in a doll 102.

Protowords

Goo goo
Ga ga
Ha Ha
Hee Hee
Uhh Uhh
Ummm

Target Words

Momma/Mommy/Mama
Daddy/Dada/Papa
Baby
Happy
Love
Hungry
Milk
Now
Sleep
Want

Metawords
Based on Target Word: “Mama”

Maaaaagoo
Maaaamummmmooooo
Haaaaaaaammaaaa
Maagaaa
Maaummmm

Target Sentences
(Not solely based on the above target words)

Baby loves mommy.
Baby loves daddy.
Baby wants milk.
Make baby laugh.
Baby go potty.
Baby wants (to) sleep, now.
Baby is sad.

In one embodiment, the protowords, metawords, and target words are all stored into memory 104 (FIG. 1), preferably read-only memory (ROM). They may be stored in its entirety, for example, if the word “mama” is stored, the entire audio representation of “mama” is stored.

They may also be stored in portions, such as syllables or phonemes, for example, only “ma” is stored. The voice synthesizer 112 then handles the synthesizing and generation of the complete word “mama.” Techniques and algorithms on how words or sounds should be stored, synthesized, and/or generated by a speech synthesizer 114 are known to those in the art. A speech synthesizer 114 not only synthesizes words, but also various sounds, like music, sound effects, etc.

The memory unit 104 may be embodied in one or more memory devices. Depending on its use, it may be programmable, nonprogrammable, volatile, and/or nonvolatile. Examples of memory units include flash memory, read-only memory (ROM), electrically erasable programmable ROM (EEPROM), and the like. The set of data that is stored in this memory unit 104 typically depends on toy design and implementation.

Memory plug-ins may also be used. A new updated dictionary for the teachable toy may also be made available for download into memory or by adding new memory plug-ins. Behavior patterns, such as being whiny, perky, happy, and giggly, may also be stored in such memory.

They may be added or revised, e.g. through memory plug-ins, or downloaded into available memory. Learning level information related to target words, target sentences, and other outputs are also stored into memory 104, preferably in a read/write non-volatile memory. Nonvolatile memory is needed to protect level learning information when the teachable toy is turned off or goes to a sleep mode, or when batteries are to be changed—so that state of learning is not loss.

A “rebirth” or “reset” button may also be incorporated in the teachable toy 100 such that generally all learning level information and data are erased—thus returning the teachable toy to its original native state of knowing only protowords and not learning/knowing any target words, sentences, and the like.

This reset switch may be hidden inside the toy 102 and be pressed in a certain time or sequence, so as not to accidentally or unintentionally cause a reset. Partial reset, such as resetting only learning of Spanish language words and not English language words or resetting only learning target sentences but not target words, may also be included in the teachable toy.

The input unit 104 is a device that accepts input, preferably audio input, from the user of the learning doll 100. This input unit 106 is preferably a microphone. Other input units 106 such as keyboards or touch-screen displays may also be used. If keyboards, touch-screen displays, and other non-audio inputs are used, some modifications to the controlling unit 110 may have to be done to handle non-audio inputs. Generally, the modifications convert and treat non-audio inputs as audio inputs.

In another embodiment, the teachable toy enables the use of audio signal input from analog sources, such as microphones, telephones (handsets, headsets, cellular, wireless), personal computers, and other audio input devices. The input audio signal, which is an analog signal, is converted into digital representation by means of analog-to-digital (A/D) converters commonly used in the field for such purposes.

The output unit 108 is a device that produces the output, preferably, audio sounds of the teachable toy 100. It is preferably an audio transducer such as a loud speaker, an earphone, or other electronic-to-acoustical wave-conversion mechanism. This output unit 108 typically projects the protowords, metawords, target words, target sentences, songs, tunes, etc. Textual representation of outputs may also be displayed through a screen.

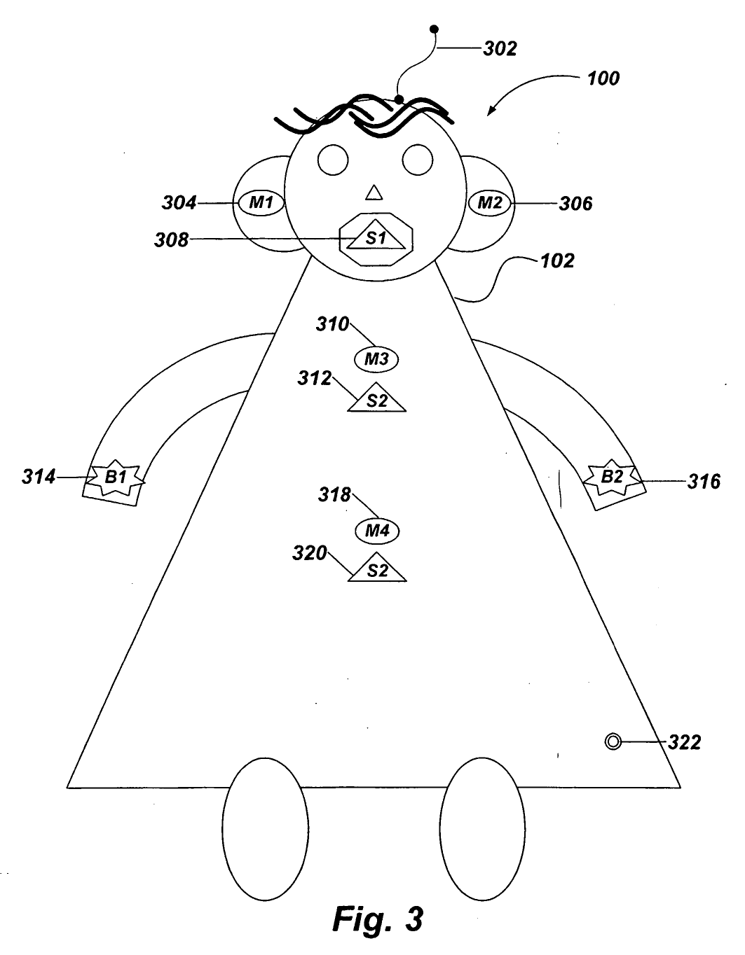

In one preferred embodiment, a number of input unit, output unit, switches, and the like are present within the teachable toy 100 (FIG. 3). A microphone each is preferably placed in the left ear 304, right ear 306, chest area 310, and tummy area 318. A speaker each is preferably placed in the mouth area 308, chest area 312, and tummy area 320.

Switches or push buttons, for example, to indicate learning speed of the toy (slow, medium, and very fast), may be placed at the end of each arm 314, 316. A number of reset buttons and sensors may also be incorporated. Other locations not described above may also be used (e.g. nose, right thumb, etc.).

Depending also on product design, the number and placement of such devices may be varied. One or more microphones may also be used in the same toy 100 for direction sensing, variable listening, and play patterns, such as asking the user to speak to the toy in a certain area—e.g. “say something to me in my right ear.”

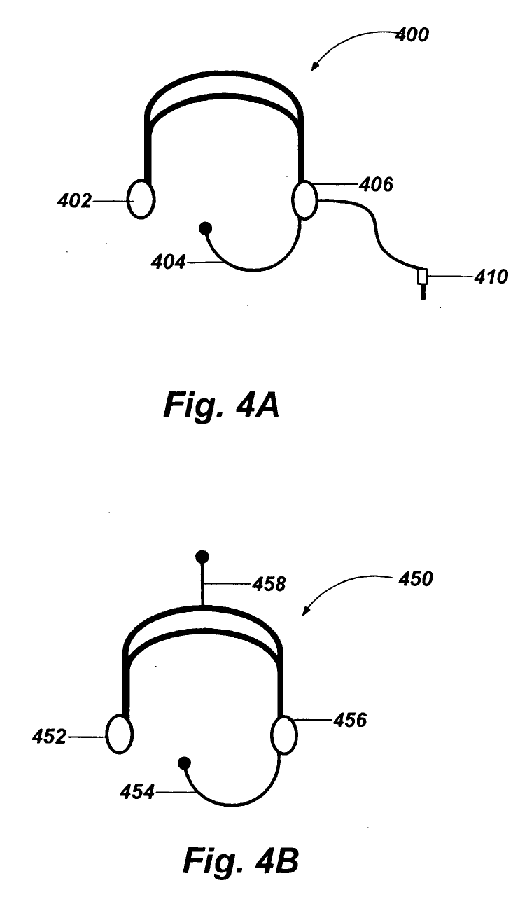

Alternate means of communicating to the teachable toy may also be designed. A wireless communication interface 302 may be added to the teachable toy 100 to receive and/or send wireless input and output. Wireless communications include radio frequency (RF) communications (e.g. 900 Mhz analog or digital transmission via RF) and infrared (IR) communications (e.g. “bluetooth” 2.4 GHz spread spectrum, and the like). A plug slot 322 may also be made available to accept wired or luggable devices, such as pluggable headsets 400 (FIG. 4A).

Headsets 400 (FIG. 4A), 450 (FIG. 4B) that include both input and output units may also be used. A pluggable headset 400 or a wireless headset 450 handles both input 404, 454 and output 402, 406, 452, 456. A user hears from the earpieces 402, 406, 452, 456 and speaks through the microphone 404, 454. The plug 410 of the pluggable headset 400 may be plugged into the plug slot 322 (FIG. 3). The wireless interface 458 (FIG. 4B), e.g. antenna, of the headset 450 may be used to interface with the wireless interface 302 (FIG. 3) of the teachable toy 100.

The controlling unit 110 (FIG. 1) is the software, firmware, and/or hardware controlling the simulation of learning of a toy 100. It is preferably a group of software programs running on a processor, for example, of a microcontroller.

The controlling unit 110 controls several functions, e.g. controls how a teachable toy 100 progresses to learn, combines or morphs the protowords and the target word to generate metawords. As other examples, it preferably controls and determines the level of learning of the teachable toy 100, controls how a teachable toy responds to a user so as to simulate a real conversation, determines how words are to be concatenated to form grammatically correct sentences, provides an expanded dictionary and thesaurus, and the like.

The voice recognizer 112 recognizes spoken words, sounds, and sentences. The speech synthesizer 114 synthesizes one or more sounds (words, phonemes, tunes, musical notes, and the like), typically stored in the memory unit 104, to generate what is to be spoken by the teachable toy (output).

This output is spoken by the teachable toy 100 through the output unit 108. What the teachable toy 100 says includes resulting metawords, protowords, target words, target sentences, music, etc. The voice recognition unit 112 and speech synthesizer 114 may be embodied in one or more devices, such as microcontrollers, chips, and integrated circuits.

Because of the recent advances in electronic voice recognition and speech synthesis technologies, it is now possible to implement reasonably accurate and high-quality voice recognition units and speech synthesizers, using low-cost electronic chips available on the market. Such chips cost in the range of two to three dollars, in large quantities, which make them suitable for use in low-cost, mass-produced toy and game products.

In this particular 3D teachable toy 100 embodiment, the voice recognition unit 112 and the speech synthesizer 114 are preferably low-cost toy-level processors and not PC-based or video game unit-type technologies. Such toy-level processors are available from companies, such as Sensory, Inc. of Santa Clara, California, Winbond Electronics Corp. of San Jose, Calif. (US sales office), Texas Instruments, and Sonic Systems.

Speaker-Dependent and Speaker-Independent Recognition

The voice recognition aspect of the teachable toy 100 of the present invention may be designed to be speaker dependent (SD) or speaker independent (SI). With SD recognition, a user trains the talking toy 100 to recognize his or her voice by speaking, for example, a set of training words a number of times. The teachable toy may then recognize SD target words when spoken by such user. Information about the speaker's voice is typically stored in a memory unit 104.

Speaker-dependent recognition leads to the personalization of the teachable toy for it is taught to recognize and respond to only a specific person, i.e. the user or “mommy.” This also means that SD teachable toy 100 may not be used “out of the box,” because pretraining is needed.

With SI recognition, on the other hand, the teachable toy 100 recognizes a target word spoken by any person or by persons with certain voice characteristic qualifiers, e.g. little girls speaking American English or teenage girls speaking Spanish. Typically these qualifiers are dictated by the product design that takes into careful consideration the expected users of the teachable toy 100.

Unlike SD recognition, an SI teachable toy is pretrained on the voices of many different speakers. Thus, any user may use the SI teachable toy generally out of the box. Accents, ages, gender, ethnic backgrounds, and the like are taken into consideration when pretraining the teachable toy for SI voice recognition.

Now-available state-of-the-art high-end voice recognition technologies having a high degree of recognition for SI sources may be experienced by phoning certain businesses and services. These systems incorporating voice recognition are typically running on high-end macro computers with plenty of processing power and costing around one million U.S. dollars.

For example, if you call the toll-free phone number for flight arrival and departure information of United Airlines, a user hears a voice of a virtual voice-operated character that queries the user for some information. This is an example of a SI voice recognition system. It recognizes the voice commands and requests of numbers, times, city and place names, and the like, of almost any English-language speaking person who happens to call.

In one embodiment of voice recognition, sensory neural network templates are used. They are used to define a sample set of expected users—e.g. users who are children, users who speak American English, users with southern accent, etc.—for SI embodiments.

Neural networks are computing devices that are generally based on brain operations. Neural networks generally learn to perform a task based on examples of appropriate behavior, in this case—speech. Unlike a typical computer that has to be programmed procedurally (step-by-step), a neural network programs itself based on examples provided by a user/trainer. Neural networks for voice recognition technology are known in the art.

Aside from voice recognition and speech synthesis, the learning aspect of the teachable toy 100 is also handled by a controlling unit 110, which is preferably software and executed by a processor. A controlling unit 110 may include a number of components (FIG. 2B), such as an artificial intelligence (AI) engine 252, a grammar engine 254, a conversation engine 256, a language engine 258, and a dictionary engine 260.

Other simulation of behavior engines may also be included to expand the features and capabilities of the teachable toy 100. A speech-and-motor-coordination engine that coordinates the movement or the animatronics of the toy with the spoken sounds or words may also be included.

A dictionary and thesaurus engine 260 may also be added to provide an expanded vocabulary, which may be used with or without prior teaching. This dictionary and thesaurus engine 260 is generally stored in memory.

An embodiment of an artificial intelligence (AI) engine 202 (FIG. 2) is preferably a group of software components executed by a CPU or a processor. This AI engine 202 controls the operation to “teach” the teachable toy 100 to speak.

It controls how fast the teachable toy 100 progresses from speaking protowords to metawords, metawords to target words, and target words to target sentences. It may also control the generation of metawords. It also determines and adjusts the “intelligence” or “skill level” of the toy, particularly, the learning level related to each target word or the learning process in general.

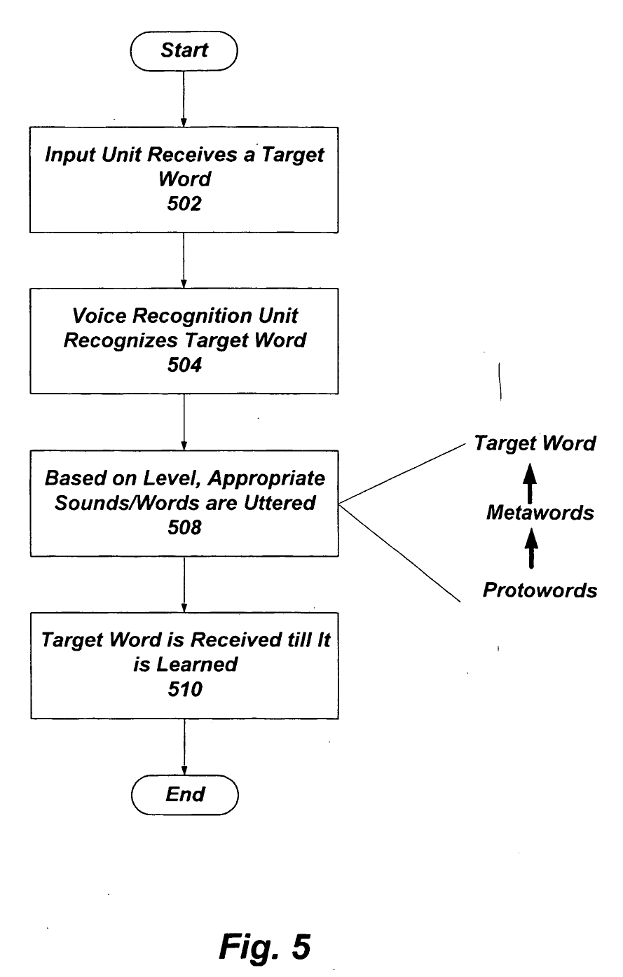

From a very basic point of view, to start teaching a teachable doll 100, assuming that the doll has already been pretrained for SD talking doll, a user whispers or speaks a target word to the input unit 106 of the teachable toy 502 (FIG. 5). In this baby doll embodiment, it is preferable that the input unit be located in the ear area considering that human beings listen with their ears. It is preferable that the user speaks slowly and clearly to enhance the accuracy of voice recognition.

Once the input unit receives the spoken target word, it is sent to the voice recognition unit 504 for processing (recognition). The voice recognizer 112 (FIG. 1) uses the dictionary of target words stored into memory 104 to recognize the word spoken. Based on the learning level information retrieved and processed, further explained below, the teachable toy utters the appropriate speech or sounds 508. What is to be uttered is generally controlled by the AI engine 252 (FIG. 2B). The speech synthesizer synthesizes the speech or sound to be outputted through the output unit 108.

Learning level information as defined herein means information related to target words, target sentences, protowords, metawords, and typically any input and/or output by the teachable toy. This learning level information is updated and keeps track of the collective progression level of learning of the teachable toy. Depending on implementation, they may be embodied in various forms. It may be embodied in a mathematical matrix model, as discussed below.

Exemplary Mathematical Matrix Model for Artificial Intelligence Learning and Speaking-Control Algorithms

In one embodiment, the controlling unit 110, particularly the AI engine 252 (FIG. 2B) is implemented using a multidimensional series of matrices that represent stages or levels of learning and control for each word, utterance, output, behavior, learning, and performance of the teachable toy 100.

The table below shows mathematical representation of how the learning level of a teachable toy is represented and handled by an AI engine 252 (FIG. 2B).

| Formula | Brief Explanation of Learning Level Information |
|---|---|
| W(n) | [Word n] |
| | This is the word matrix where W(n) contains the target words to be |
| | learned. Collectively, they represent the dictionary of the teachable |
| | toy. The number of words (n) is dependent on system design, e. g. |
| | 10, 20, 10,000, or 100,000. |
| L(W(n), m) | [Learned Word n to level of learning m] |
| | This matrix contains markers, flags, and/or counters for each target |
| | word that is learned or to be learned. It tracks the progress of each |
| | target word, i. e. it indicates the degree or learning level of each |
| | word. Generally, this field is incremented each time the target word |
| | is recognized, until it is fully learned. A set of criteria on when a |
| | word is fully learned may be set, e. g. a target word is fully learned |
| | after it has been recognized thirty times or when playtime is over |
| | thirty hours. |
| MW(n, m, p) | [Metaword n, used m times, and permuted p times] |
| | Tracks how many times a particular metaword has been used and |
| | permuted. |
| PW(n, m, p) | [Protoword n, used m times, and permuted p times] |
| | Tracks how many times a particular protoword has been used and |
| | permuted. |
| KNW (n, j, f) | [Knows Word n in form(f) j times] |
| | Tracks how the teachable toy knows a particular target word. |
| | The form indicates the variation of the word, for example, for the |
| | word “mother,” other forms or synonyms may exist such as |
| | “momma,” “ma,” and “mama.” |
| USW (n, k, f) | [Uses Word n k times and in form f] |
| | Tracks the number of times the target word has been used in form |
| | (f). |
| HRW (n, m) | [Heard and Recognized Word n for m times] |
| | Counter. Tracks how many times a particular word has been |
| | recognized. |
| UWS (w, s, m) | [Used Word (w) in Sentence (s) a total of (m) times] |
| | Tracks how many times a particular target word has been used in a |
| | particular target sentence. |
| S(n, m) | [Sentence matrix for sentence n used m times with word n] |
| | Tracks how many times a particular target sentence has been used |
| | with a particular target word n. |
| SC*(n, m, w) | [Sentence Concatenation: used sentence n for m times with word w |
| | and/or words (w(i)-w(j))] |
| | Tracks how many times a particular sentence concatenation or phrase |
| | has been used with certain particular target word or words. |
| S1(s, c) | [Sentence 1 using Word W(n, m)): one-word sentence, subject/topic |
| | c] |
| | Defines a particular sentence or phrase, e. g. “Hi,” and what topic |
| | this sentence relates to, e. g. greeting. This may be used in |
| | simulating a conversation with a user. |
| S2(s, c) | [W(n) * W(n + I): two-word sentence, subject/topic c] |
| S3 (s, c) | [W(n) * W(n + I) * W(n + j): three-word sentence, subject/topic c] |
| S4(s, c) etc. | Four-word sentence, subject/topic c |
| HYN (W(n), m) | [Homonym Word n for m times or cases] |
| | To distinguish words which sound alike. |
| SYN (W(n), m) | [Synonym Word n for m times or cases] |
| | To distinguish words with similar meanings. |
| LB(n, m) | [Spoken Language Base n and cross language m] |
| | May be used to indicate operating language(s), e. g. English or |
| | Spanish. |

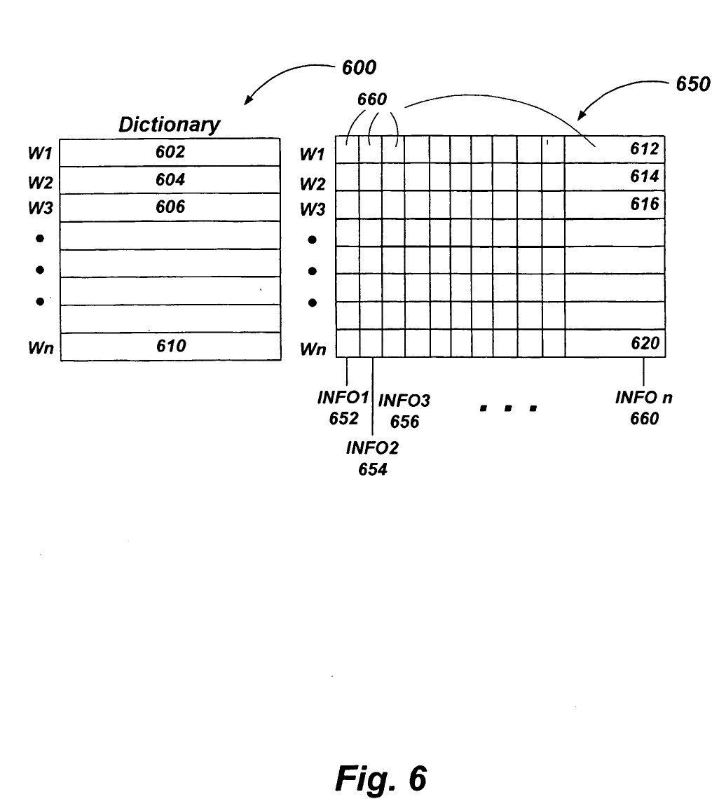

One possible implementation of the above-mentioned matrices and control model is in the memory space of a memory device 104 (FIG. 6). Generally, a memory space is preferably allocated for each target word, target sentence, metaword, and protoword.

In this embodiment, each target word is contained in a word list or dictionary 600. Each target word W1, W2, W3, . . . ,Wn 602, 604, 606, . . . ,610 is stored into memory. Associated with each target word is a set of learning level information 612, 614, 616, . . . , 620. Each set of learning level information contains fields 652, 654, 656, . . . , 660.

These fields are typically status information contained in flags, counters, indicators, and the like. These fields may include the number of times a particular target word (Wn) has been heard and recognized, the number of times a particular target word has been spoken (also in relation to particular target sentences), whether a word is unlearned, partially-learned, or fully-learned, whether the word is a protoword or a metaword, what sentences a particular target word is included in, the homonyms and synonyms of a particular target word, and the like. The AI engine 252 (FIG. 2B) preferably sets, updates, and clears various fields 660, including bit flags, counters, and the like.

In one embodiment, homonyms are treated by the controlling unit 100 as the same word, unless there is a context for that target word, which the controlling unit may be able to determine. For example, the word “right,” unlike “write,” may be used in a directional context, such as “move my right hand up or down.” This may be incorporated into the artificial intelligence engine 252 (FIG. 2A) as an advanced feature. Variations on how and when homonyms are used and/or learned generally depend on product design.

The learning progression or the factors or criteria affecting learning levels, e.g. marking a target word partially or fully learned, are not limited to having the target word be recognized by the teachable toy. Other programmed or user-defined criteria for learning levels may also be set.

In addition to hearing the words, the amount of sensory stimulation may influence the learning level information stored for a teachable toy, and thus affecting the progression of learning by the teachable toy. For example, the setting on a switch or selector mechanism set by the user, the amount of stimulation, amount of playtime (using timers), number of times a bottle has been given to the teachable baby doll, number of times a button has been pressed, amount of time the teachable toy has been ON, and the like may influence the value stored (learning-level information).

In one embodiment, just by having the teachable toy be ON and listening to the environment for sound and words stimulation, the teachable toy appears to learn or pick up target words and sentences. The teachable toy 100 thus may include sensors—motion sensors, light detectors (photo sensing element such as a photo resistor or photovoltaic sensor), touch sensors (feeding the toy with simulated food or drink stimulates the touch sensor), clocks, timers, calendars, radio frequency (RF) ID tags and/or sensors, sensor readers and interrogators, etc.

The RF ID tags may identify, for example, an object brought near to a teachable toy, e.g. an apple, and may also be used to teach a toy. When an RF ID sensor senses the RF ID tag for the apple, a teachable toy is able to identify and say, if appropriate, that the object is an apple. Timers, clocks, and calendars may be also used to log play and/or teaching time. They may also be used so that the teachable toy says particular words and/or sentences appropriate for that time of day or day.

Initially, the teachable toy 100, for example, if embodied in a baby doll 102, just babbles, gurgles, coos, and squeals, i.e. just utters protowords. Generally, to teach a teachable toy to learn a target word, the user has to speak the target word to the toy 100 a certain number of times.

Generally, the more the user repeats the target word, the faster the teachable toy fully learns the word. Ultimately, the teachable toy learns the word and correctly says it. Using the learning unit 120, the teachable toy “learns” to talk just like a real baby, albeit at an accelerated pace.

The number of times a target word has to be spoken before the teachable toy (partially or fully) learns to correctly say the target word depends on product design. It may be defined or hard-coded as part of the AI engine 202 and/or it may be varied by the AI engine 202 based on various criteria discussed above.

The “intelligence” of the teachable toy may also progress so that the items spoken become more sophisticated—from words to phrases, from two-word phrases to three-word sentences (“Happy Daddy” to “Baby loves Daddy”), from phrases to sentences, etc. Eventually, the teachable toy may say target phrases/sentences and speak on a number of topics such as food (e.g. “Baby Hungry” and “Baby wants milk”), affection (e.g. “Baby loves mama” and “Baby loves daddy”), or mood (e g “Baby is happy” and “Baby is sad”).

Generally, the target phrases/sentences are based on the fully learned target words. In one embodiment, it is not necessary to fully learn all the target words before the teachable toy says target phrases/sentences.

In another embodiment, a selector switch may be set to indicate the intelligence or smartness level of the teachable toy. This indicates how quickly the teachable toy learns new target words, e.g. the number of times each target word has to be heard and recognized to be fully learned.

In another embodiment, word evolution may also be included. For example, if a teachable toy has fully learned the base word “mama,” synonymous words related to “mama” may also be automatically and gradually learned—“mommy,” “mother,” “mom,” “ma,” etc.—even without such synonyms taught to the teachable toy. Synonyms may be learned based on certain criteria, such as the number of times the base word (e.g. “mama”) is recognized or amount of time elapsed after “mama” has been fully learned. These synonyms may also be used to form target sentences 220, even if they are not learned by the teachable toy.

Let us assume that the word to be learned is “mama” and that the user has to speak a particular target word twenty times before the teachable toy fully learns that word. The first five times that the teachable baby doll recognizes the “mama” target word, it just gurgles, coos, and squeals (protowords).

During the next five times “mama” is recognized, the teachable baby doll starts to utter “mmmmm” sounds (portion(s) of the target word) combined or mixed with a variable percentage of protowords, e.g. fifty to seventy-five percent baby squeals and coos (protowords). This combination is a metaword.

The next five times, the teachable baby doll utters more of a “mmmmmmmmmuh” sound (more of the target word) mixed with twenty-five to fifty percent baby sounds. The next five times, the teachable toy starts to sound really good and utters sounds like “mmmah-ah-mmmm” with the level of baby sounds (protowords) reduced to five to twenty-five percent.

Finally, after “mama” is recognized at least twenty times, the teachable toy fully learns and correctly says “mama.” At this time, the teachable toy may also squeal in delight, laugh, and play a musical tune.

The teachable toy may also get so excited that it just keeps saying the target words over and over again for a fixed period of time. The percentage of protowords is for exemplification purposes and may be varied based on product design.

Generally, once a target word is fully learned it is not forgotten, meaning from that point on it says “mama” correctly. This may be done by marking the target word as learned in a non-volatile memory unit so that the learned word is always known even when the teachable toy is turned off or in the sleep mode, i.e. the learning level information for “mama” is updated and stored accordingly. The above basic process is repeated to learn other target words.

The now-available voice recognition devices and technology do not work perfectly. Sometimes a target word has to be repeated several times before the device (e.g.. chip or processor) correctly recognizes the word. Although this may be considered a fatal flaw for specific question-and-answer type games, this works to the advantage of the teachable toy. In a question-and-answer type game (e.g. Toy: “How much is three plus two?;” User: “Seven.” Toy: “That is correct.”), it is possible that the voice recognition unit mistakenly recognizes “seven” as “five.” This mistake is unacceptable for certain game scenarios.

For the illustrated teachable toys, this inaccuracy or flaw just makes the teachable toy appear to have a more difficult time learning the spoken target word—just like a real baby or child would struggle to learn a new word. Thus, in the above-discussed example wherein “mama” is being taught, if the word “mama” is not correctly recognized twenty times out of the twenty times it was spoken, the user just has to say “mama” an additional number of times. “Mama” thus seems to be a word harder to learn than others.

The teachable toy also generally responds to the user with a tendency to assume a word close to the match, thus a word may be noted as being said an additional number of times even if it is not. This is, however, not a problem because it just makes this word appear easier to learn than others. As long as the teachable toy eventually learns the word or at least progresses in learning a target word, it is not critical that the target word be spoken and learned in the precise required number of times.

To ensure that the teachable toy learns a target word within a reasonable number of tries and not fail to learn it at all, convergence algorithms may be used. Similarly, other mechanisms may also be employed such as by using an “elapsed-play-time” mechanism that counts and stores in a nonvolatile memory unit the amount of playtime with the teachable toy and automatically forces the teachable toy to fully learn the target word if one or more criteria are met.

The set of target words that may be taught to the teachable toy depends on product design. The set of target words are predetermined and preprogrammed in one or more memory units, preferably ROMs.

In another embodiment, additional target words may be taught (dictionary expanded) by using an extension package (e.g. expansion memory cartridge), or by downloading additional target words from the Internet or from other computing devices via a CD-ROM or other mass memory storage medium. In another embodiment, the set of target words are decided by the user, for example, by using a certain target word cartridge as opposed to another, by downloading the desired target words from the Internet or another memory storage device, or by typing in words to be learned via a computing device interfacing with the teachable toy. Add-on accessories may be used, as well.

The sequence of teaching the target words and the number of words that may be taught at a particular time also depend on product play pattern design. Let us assume that there are five target words—mama, daddy, love, baby, and happy.

In one embodiment, the target words are to be learned in a specific sequence, i.e. mama first, followed by daddy, followed by love, and so on. In another embodiment, the user decides the order by having the user speak the target words in the sequence he or she desires. In another embodiment, only one target word may be taught at a time, i.e. “daddy” cannot be taught or learned until “mama” has been fully learned. In another embodiment, more than one target word may be learned at a time, i.e. a child may teach mama, daddy, and love even before any of these words are fully learned by the teachable toy.

A grammar engine 204 (FIG. 2) may also be incorporated in the teachable toy so that it speaks grammatically correct target phrases and target sentences. In this embodiment, the target words are preferably classified into categories—nouns, verbs, adjectives, adverbs, etc.

This grammar engine 204 may also be used to assist in generating grammatically correct target sentences for the teachable toy to say. In one embodiment, after a certain number of target words are learned, the teachable toy may start uttering target phrases and sentences, such as “Happy Baby,” “Happy Mama,” “Happy Daddy,” or “Baby love(s) Mama”.

In one embodiment, the teachable toy always speaks grammatically correct target sentences, and thus may be used as an educational toy, for example, for teaching proper language skills. The grammar engine may also enforce grammar and syntax rules of a particular language.

As the teachable toy learns more new words, it also progressively learns to talk more often and say more target words, phrases, and sentences. Grammar and syntax checking technologies are known in the field.

A conversation engine 202 may also be included to control and enable the toy to intelligently respond to a user, i.e. to simulate an intelligent conversation between the toy and the user. For example, if the user says “How are you?,” the teachable toy may respond by saying “Fine, thank you,” “Baby hungry,” “Baby sad,” and the like.

Another example is, if the user asks the toy, “Are you hungry?,” the toy 100 may accordingly respond with “Baby Hungry.” This way the toy may simulate, for example, a real child. This may be implemented via the mathematical matrix described above, particularly indicating to which topic/subject a particular sentence is related.

The language engine 208 may also be incorporated such that one or more different languages (e.g. English and Spanish, English and French, Spanish and Chinese, Japanese and English, etc.) may be taught. This embodiment may be useful in teaching a child or an adult person different languages.

A master base language (LB (n, m)) matrix, briefly discussed above, may be used to implement this feature. This matrix indicates the master language or languages in operation for that particular teachable toy.

When more than one base language are in operation, translations of target words and sentences from one language to another may be implemented. For example, when an English word or sentence is recognized by the teachable toy 100, the English word or sentence is spoken in a different language, or in all operating languages, so as to teach a user/child how to speak in different languages.

The language base may also be implemented such that a switch is incorporated in the teachable toy so that a user may choose the operating language(s). Switching the master base language from one language to another may be used to help teach children and even adults how to say certain words and sentences in a different language.

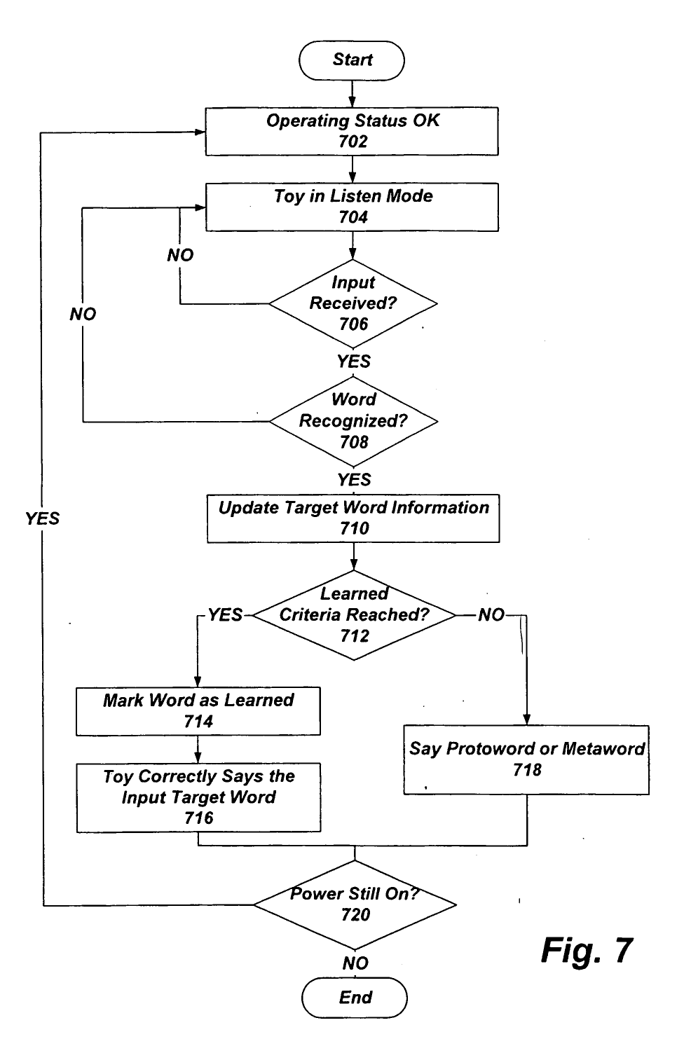

To teach a teachable toy to speak, a set of exemplary operations is discussed (FIG. 7). In this embodiment, the toy may also include a number of indicators, e.g. three, colored red, green, and yellow, placed in various places (e.g. the eyes).

These indicators may be LEDs. The teachable toy may be turned on in a number of ways—by pressing a button, shaking the teachable toy (sensed by a motion detector), moving one of the limbs, etc.

To indicate that the teachable toy is ready (operating status OK), the three LEDs are flashing 402. While waiting for input target words from a user, the teachable toy may utter protowords—e.g. a baby doll utters baby sounds every few seconds or at random intervals or a parrot makes squawking sounds every certain period of time.

Between each utterance, for example, the teachable toy goes into the listen mode for a few seconds. During this mode, the yellow LED goes on solid to indicate that the teachable toy, particularly its input unit, is waiting for input from the user 704.

If a sound is detected 406, the red LED goes on solid, along with the yellow LED, to indicate that the teachable toy is actually hearing or accepting some sounds or input. If the voice recognition unit 112 (FIG. 1) recognizes the input as a target word 708 (FIG. 7), the green LED goes on solid while the red and yellow LEDs go off.

If the input, however, is not recognized, the red LED goes on solid while the green and yellow LEDS are off. This condition holds for one or two seconds, and the teachable toy returns to the listen mode again. If no sound or input is heard or received by the input unit within a certain number of listen mode loops or after a certain number of time or other criteria, the teachable toy may utter more protowords—for a baby doll, may make more baby sounds.

If the input is recognized, depending on the learning level stored into memory (e.g. the number of times the input target word has been said and recognized), the teachable toy may just utter protowords, utter metawords, or correctly say the recognized target word. For example, if the baby hears “Mama” and the voice recognition unit correctly recognizes the input target word, the sequence of spoken sounds may sound (or be visually or textually represented, further discussed below) like that listed in the table below, assuming that a word is learned after hearing it five times.

| Number of | |
|---|---|
| Times “Mama” | |
| has been Spoken | Words Uttered |
| 1 | mmmmmm + gaa gaa + goo doo (protoword) |
| 2 | mmmmmm + hah hah (protoword) |
| 3 | hah hah + mmmm + maaaaa (metaword) |
| 4 | mmmmmm + uh + mmmmm + mmmmm + |
| | mmmmm (metaword) |
| 5 | mm + ha + mm + ha (metaword) |
| 6 | Mama! |
| | Mama! |
| | Mama! (target word spoken three times) |

Generally, if a target word is recognized as fully-learned, the controlling unit 110 (FIG. 1), particularly the AI engine 202 (FIG. 2), updates the learning level information related to that particular target word, including sentences that use that target word. This update may include incrementing a word-heard counter, for example, the L(W(n),m) matrix discussed above.

For example, it the user says “mama,” and the voice recognition unit recognizes “mama” for the first time, the AI engine 202 sets the mama word counter to one. If the child says it again, and it is recognized, the mama word counter is set to two. If the user then says “Daddy,” and it is recognized, the daddy word counter is set to one. The user can then teach “mama” and then “daddy” again until both words are fully learned. The word counter is used by the AI engine to determine the output, e.g. if protowords, metawords, and/or the target word is to be spoken or outputted.

If the criterion to fully learn a particular target word is met 712, the AI engine marks the target word as fully learned 714. The toy then correctly says the target word 716. If the criterion, however, is not met, either one or more protowords and/or one or more metawords are spoken 718. It is possible that during the state where metawords are spoken, protowords are also spoken. If the power is still on 720, the process may be repeated as desired to enhance teaching of a target word or to teach a new target word.

In one embodiment, the teachable toy after learning a certain group of target words may freely makeup phrases and sentences (“Baby wants mommy,” “Baby loves mommy,” “Baby hungry,” etc.). This may be controlled by the AI engine 202 and/or the grammar engine 204. In another embodiment, these target sentences may have to be taught and heard similarly to how target words are taught.

Other sounds may also be mixed in to have a realistic effect, such as laughing and giggling baby sounds. In one embodiment, if during a listening mode several target words are heard, the teachable toy processes all those target words accordingly.

In another embodiment, a teachable toy may include information indicators or displays, e.g. LEDs, a scrolling screen display, etc., showing learning level information. This display may also be used to visually show the visual textual representation of the audio output, i.e. the output is not only heard but also read.

This may be accomplished by storing both the audio form and textual spelling of each target word, protoword, and/or metaword as part of the dictionary 600 (FIG. 6). Thus, when an output is created, the controlling unit may also accordingly retrieve and generate the textual output. Icons and graphical indicators may also be displayed, such as a green bar line indicating the level of learning.

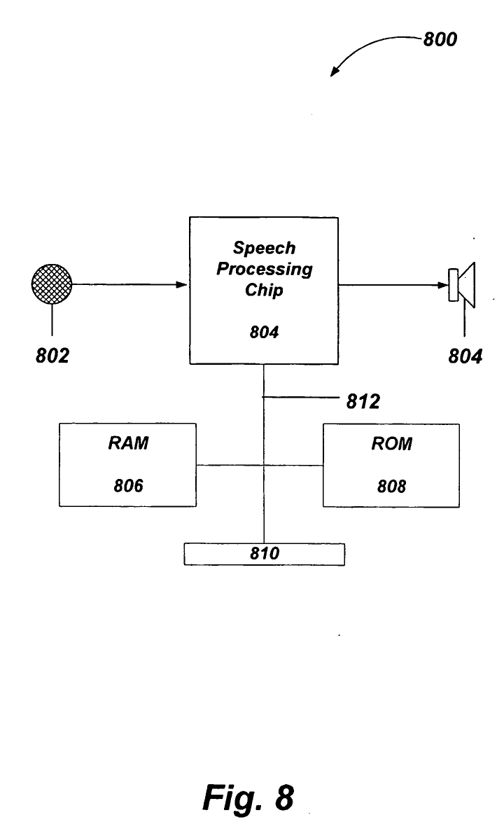

In a preferred embodiment of the invention, an integrated circuit (IC) 800 (FIG. 8) is used as part of a learning unit 120 (FIG. 1). This exemplary IC 800 (FIG. 8) is the RSC-300/364 available from Sensory, Inc. It is an eight-bit microcontroller designed for speech applications in consumer electronic products. It supports voice recognition and speech synthesis.

Other ICs, devices, chips, etc. available in the market may also be used so long as it can be used to implement some or all features of the invention discussed above. Thus, it is possible that the learning unit 120 (FIG. 1) or portions thereof may be embodied in more than one device, e.g. more than one IC.

An embodiment of the learning unit 120 (FIG. 1) may be implemented using this IC or speech processing chip 800 (FIG. 8), with additional electronic circuitry, if necessary, software code (particularly, the controlling unit 110), and speech/voice/music data files. This IC 800 interfaces with other external components such as a microphone 802, and a speaker 804. The microphone 802 is the audio input unit 108 (FIG. 1). The speaker is the audio output unit 108 for voice, sounds, music etc.

The speech processing chip or IC 800 also interfaces with a random access memory (RAM) 806, a ROM 810, and an expansion memory connector 810 through an A/D converter bus 812. The expansion memory connector 810 may be used to expand the dictionary of the teachable toy.

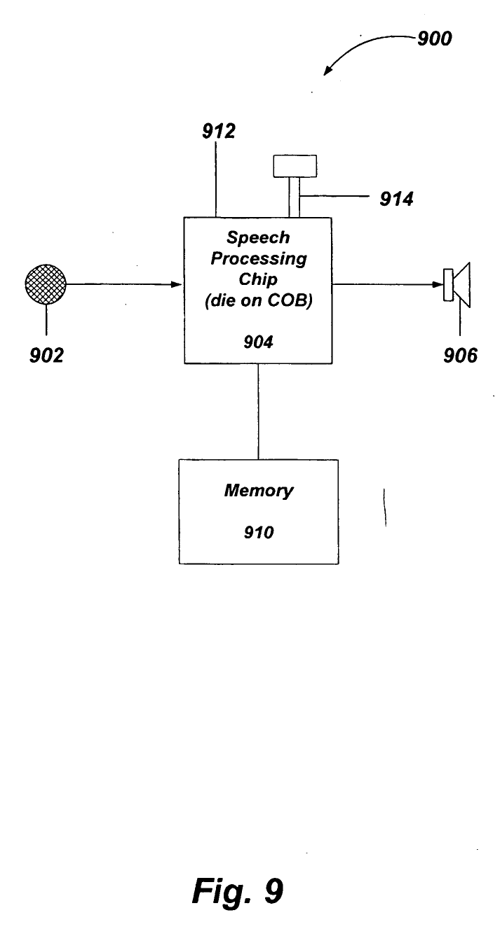

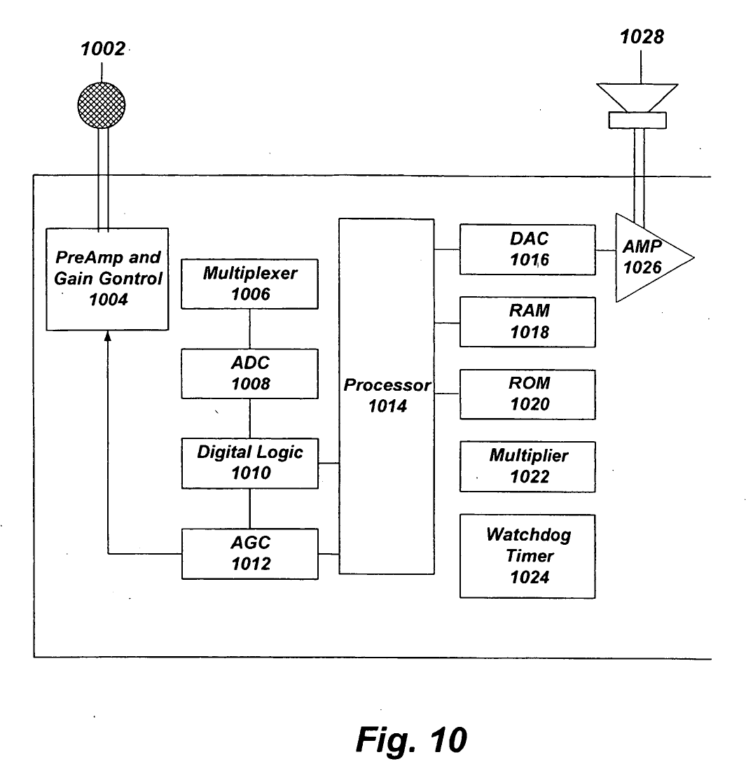

In another embodiment, the IC 904 (FIG. 9) is also an RSC-300/364 but is a DIE chip-on-board. This speech-processing chip 904 may interface with external components, such as reset switches, plug-in devices, and miscellaneous switch contacts. It may also interface with a memory device 914, preferably a one hundred twenty-eight-byte serial EEPROM that stores the controlling unit 110, a memory device 910, preferably one to two megabytes to store metawords, protowords, target words, and learning-level information. This chip 904 is powered by a power source such as AA batteries.

In general, a speech processing chip 804 (FIG. 8), 904 (FIG. 9) of the present invention may include various hardware/software/firmware components such as an interface to a microphone 1002, an interface to a speaker 1028, a preamplifier and gain control 1004, a multiplexer 1006, an A/D converter 1008, a digital logic 1010, an automatic gain control 1012, a processor 1014, a digital-to-analog (D/A) converter 1016, a RAM 1018, a ROM 1020, a multiplier 1022, a watchdog timer 1024, and an amplifier 1026. This speech processing chip also supports SI voice recognition, SD voice recognition, and speech and sound synthesis, i.e. the voice recognition unit 112 (FIG. 1) and speech synthesizer 114 are embodied in this same IC 804 (FIG. 8), 904 (FIG. 9).

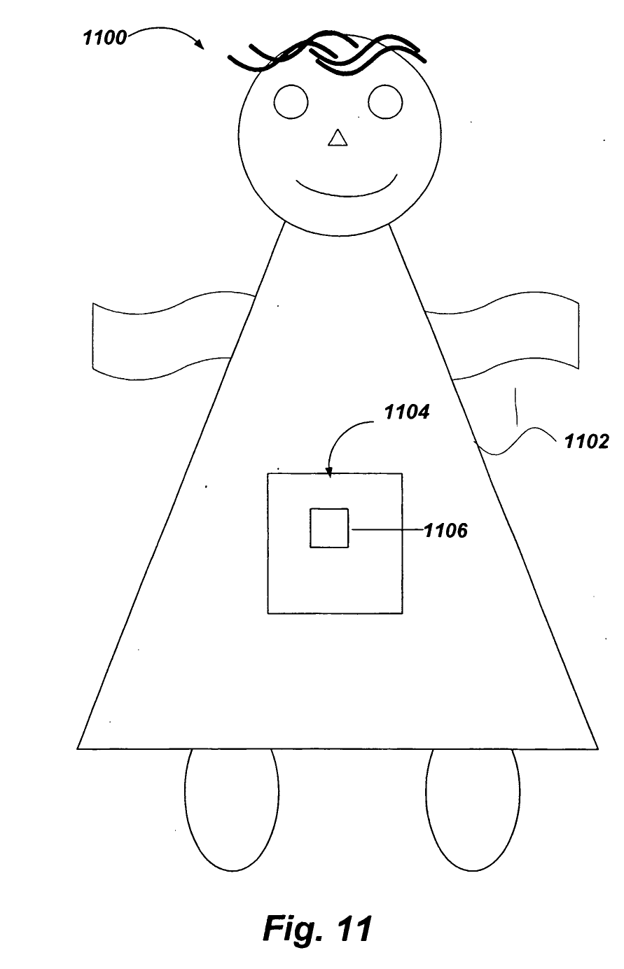

Using a speech processing chip 904, 1106, a teachable toy 1100 (FIG. 11) may be created. This is basically done by including, such as placing and integrating, this chip 1104 on a printed circuit board 1104 and placing the finished board within a 3D toy 1102.

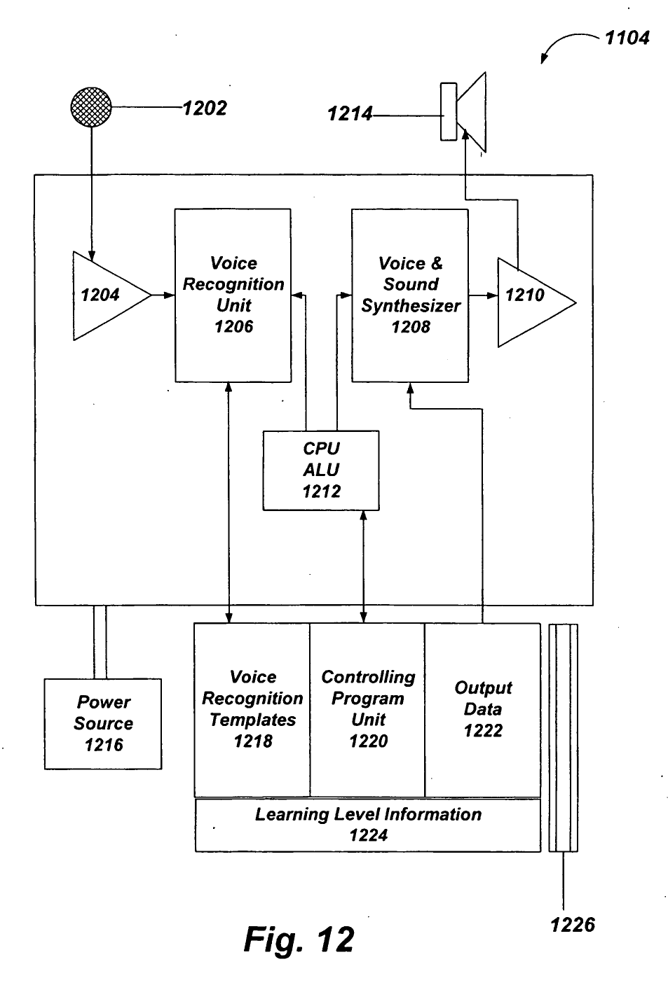

This speech-processing chip 1104 (FIG. 12) included in the above toy, preferably receives audio input from a microphone 1202. This microphone 1202 is connected to the audio input line of the IC. The audio signals are amplified internally by an amplifier 1204 and automatic gain control is applied. A/D conversion is also done.

A voice recognition unit 1206 processes the input. In this embodiment, the voice-recognition aspect is based on well-known pattern matching techniques also known as neural networks. Representation templates of target words, either SD or SI, may be stored in ROM or in a read/write memory. These templates 1218 are compared to input data patterns for matches and close proximity matches, with ranking of degree of match.

Word spotting may also be implemented so that the teachable toy may be taught to respond to its own name using a particular SD word. In this case, only a certain user's (child's) voice activates the teachable toy. The teachable toy may be taught to learn its own name by having a user record that name in a particular memory space. Word spotting is known to those in the art.

The voice recognition unit 1206 works in conjunction with a processor 1212 (CPU and ALU registers) under the control of a controlling program or unit 1220. It 1208 includes a D/A converter, which accesses digital data into memory.

Based on the instructions of the control unit 1220 and whether an input has been recognized, the voice/sound synthesizer 1208 synthesizes the appropriate audio output using an amplifier 1210 and projects such output through a speaker 1214. The speech synthesizer 1208 retrieves certain information from a pool of potential output data 1222 to synthesize an appropriate output.

The voice recognition templates 1218, controlling program unit 1220, and output data 1222 are preferably stored in ROM. Learning level information 1224 that controls the progressive learning behavior of the teachable doll is preferably stored in non-volatile read/write memory. This learning level information 1224 may also be retrieved or used by the processor 1212, voice recognition unit 1206, and voice synthesizer 1208.

The IC 1104 also includes a number of digital input/output lines, which may be connected to push buttons, multiple-position slide switches, and other types of mechanical electrical switches. It may also be connected to sensors such as motion-sensors, photo-sensing devices, and sensors that sense temperature, wetness, and other physical parameters.

These buttons, switches, and/or sensors may be sensed by the controlling program unit to control the learning level, detect motion and handling, detect the temperature of the toy, and other realistic simulations. The mere placing of a toy in a room by a child, for example, may trigger changes in sensor readings, such as when the temperature in the room eventually rises or when the sounds in the room decreases in loudness.

Virtual Audio and/or Visual Toy (Virtual AV Toy)

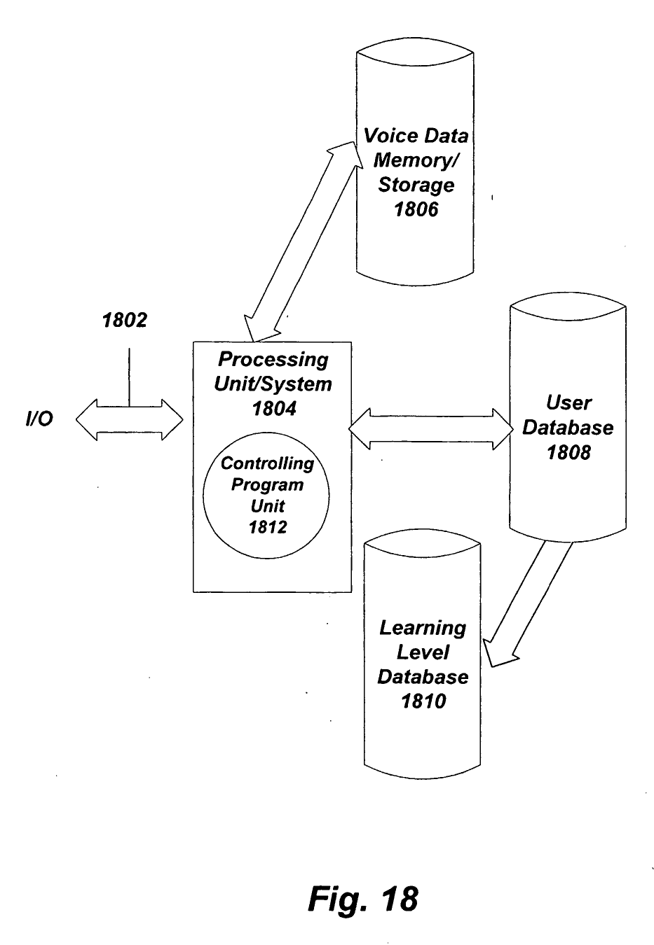

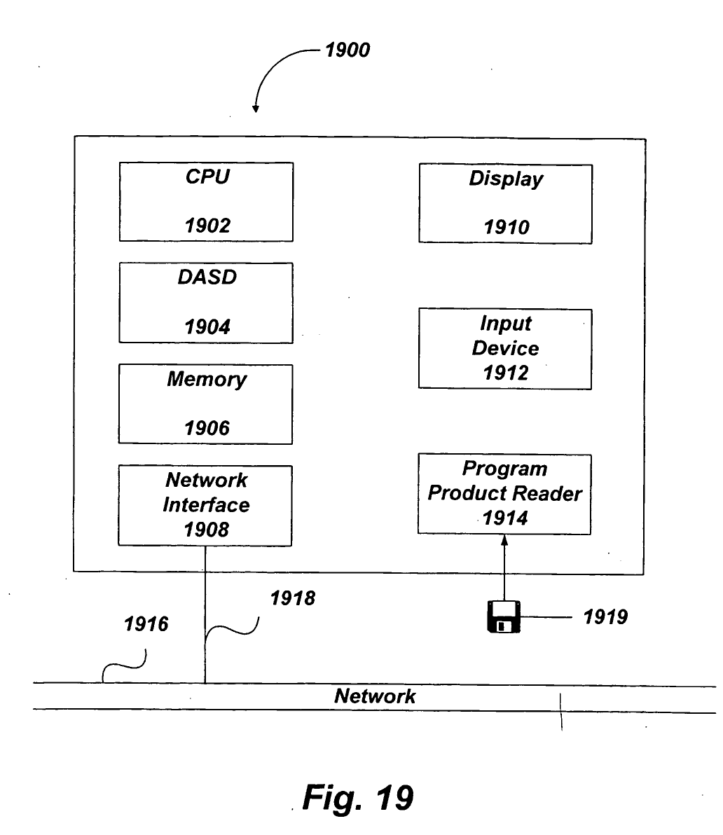

In another embodiment of the invention, a virtual audio and/or visual toy (virtual AV toy) 1304 (FIG. 13) simulates speech learning. Similar to the 3D tangible teachable toy 100 (FIG. 1) discussed above and the virtual audio toy (FIGS. 17 and 18) discussed further below, the virtual AV toy 1304 (FIG. 13) simulates the learning of speaking words, phrases, sentences, and even carrying on a seemingly intelligent conversation.

Instead of a teachable toy in a 3D tangible form, this virtual AV toy 1304 is a visual character or representation on a display 1302, similar to characters in computer and video games. These virtual toys, however, may be represented using two-dimensional or three-dimensional techniques (e.g. 3D stereographic display, holographic animated display, and the like). The features and functions described above with regard to the 3D tangible/physical-teachable toy also apply to the virtual AV toy, with some minor modifications.

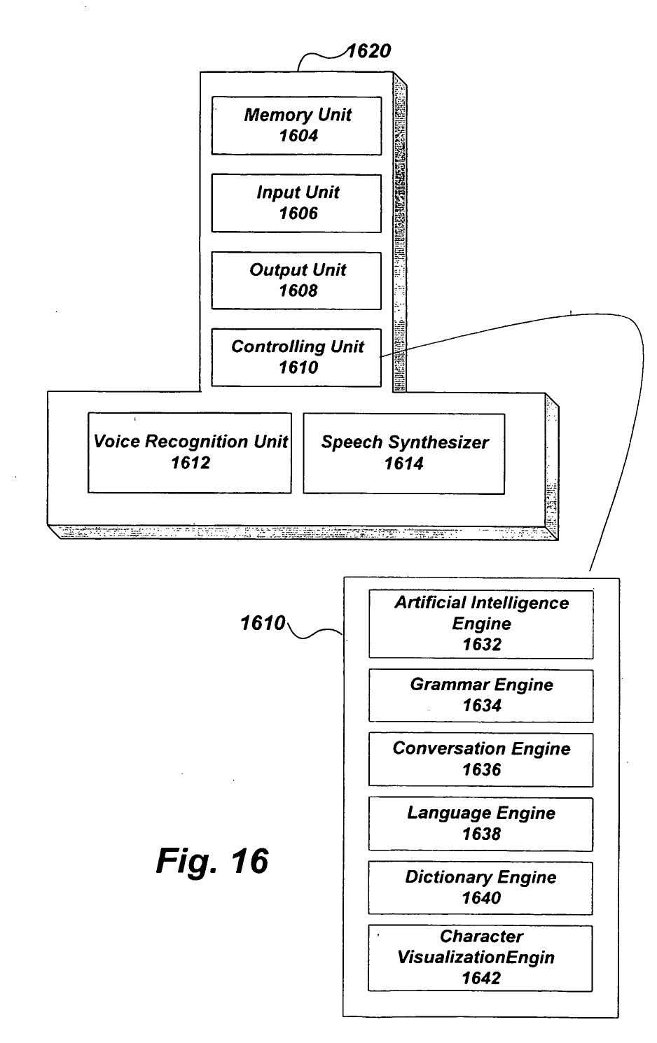

The system 1300 to create such teachable virtual AV toy 1304 typically includes a processing unit 1350, e.g. a computer. Similar to the 3D teachable toy 100 (FIG. 1), the system 1300 (FIG. 13) also includes a learning unit 1620 (FIG. 16) comprising a memory unit 1604, an input unit 1606, an output unit 1608, a controlling unit 1610, a voice recognition unit 1612, and a speech synthesizer 1614. The learning unit 1620 is preferably embodied as all software, although some components may be implemented in hardware and/or firmware.

The input unit 1610 is preferably an audio input unit such as a pluggable microphone 1314 (FIG. 13) or a wireless microphone (e.g. RF or IR) 1316. The wireless microphone 1318 communicates with a wireless interface 1318.

The output unit may be a set of speakers 1306, a pluggable headset 1310, or a wireless headset 1322. The wireless headset 1322 communicates with a wireless interface 1320.

In this embodiment, the form of the toy is non-tangible 1304, i.e. it is displayed on a screen device (CRT, LCD, etc.). The display may show two-dimensional and/or three-dimensional characters. The output is preferably audio, similar to the teachable toy 100 (FIG. 1). It is, however, feasible that the output may also be a visual textual representation of the audio output 1328. For example, in addition to hearing the spoken word “mama,” the user also sees “mama” on the screen. The script used may depend on the language being displayed, for example, roman characters for the English language, kanji for Japanese, and the like.

Similarly, the input may also be via a keyboard received by the processing unit 1350 rather than via an audio input 1314, 1316. If a keyboard is used to enter text to train the teachable toy, some modifications to the controlling unit 1620 (FIG. 16) may have to be done to handle such type of input.

The voice recognition unit 1612, speech synthesizer 1614, and controlling unit 1610 (FIG. 16) may be embodied in at least one software program that may be installed and run in a personal computer. The voice recognition unit and speech synthesizer may be implemented using existing hardware or firmware, such as via specialized cards inserted into the computer.

Voice recognition technology and speech synthesis in software are known in the art. A similar implementation of voice recognition technologies combined with customized components, preferably software, results in this virtual teachable character 1304 (FIG. 13) that is seemingly taught to learn how to speak.

The controlling unit 1610 (FIG. 16) contains the instructions to handle the features and components of the virtual AV toy, which are similar to those discussed in the 3D teachable toy section of this application.

The controlling unit 1610 may include an AI engine 1632, a grammar engine 1634, a conversation engine 1636, a language engine 1638, and a dictionary engine 1640. To display the visual representation 1304 of the virtual AV toy, a character visualization engine 1642 is included. It may also include an engine that displays the visual textual representation 1328 of the output.

As known in the art, the software components for this virtual AV toy may be run on one or more computers. The software components may be resident in the internal hard drive (memory unit) or in one or more external memory devices, such as floppy disks, CD-ROMs and memory devices.

The software components may also be downloaded via the Internet. Processing may also be done on the client (user's computer) and/or the server side (externally located computer). The software components may also be accessed using a wired or wireless data network such as a LAN, WAN, or wireless RF.

The virtual AV toy may also be incorporated in various software components. For example, the teachable features of this toy may be incorporated in role-playing games, screen savers, educational programs, and the like.

Assume for example that a software program is designed that provides virtual pets to computer users. Using this software, a computer user adopts, plays, feeds, and teaches this virtual pet. Let us assume that the virtual pet is a parrot.

One of the tasks that a computer user does is to teach his or her parrot how to talk. The virtual AV toy of the present invention may thus be incorporated in this pet software program to teach this parrot how to speak. The virtual AV character and its features and functions may be incorporated through software objects, class libraries, dynamic link libraries (DLLs), and the like.

An off-the-shelf software package may be developed to support virtual AV toys. This software is then installed in a personal computer and accordingly run—similar to buying, installing, and running a game software. Once the software is run, a virtual AV toy may be created, interacted with, and taught to learn how to speak. A 3D tangible toy may also interface with the virtual system 1300 and be controlled by the same running software (with some modifications).

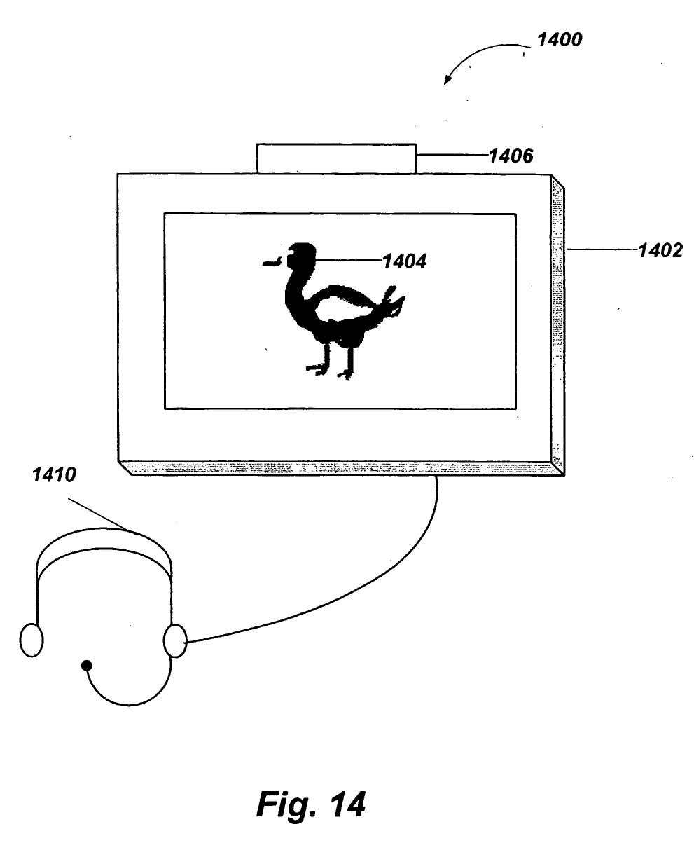

In another embodiment of the virtual AV toy, a hand-held computing or game unit device 1402 is used (FIG. 14). This hand-held device may be a hand-held game playing unit or hand-held processing unit, e.g. Game Boy Advance from NINTENDO, a PDA, iPAQ Pocket PC from COMPAQ, etc. The audio input and audio output are handled by a pluggable handset 1410. Visual/textual representation of the output, including the non-tangible form 1404 of the toy, may also be displayed on the screen 1402 of this device.

The headset 1410 enables a user to speak with and teach the virtual AV toy 1404. Preferably, an auxiliary circuit card 1406 with a voice recognition unit (e.g. voice recognition circuits) and speech synthesizer is plugged into a memory or accessory expansion slot of the hand-held device 1402.

This circuit card 1406 supports the voice response features (synthesis and recognition), performs A/D conversion, and the like. The hand-held device 1402 may also have built-in A/D converters and sufficient CPU processing power to support voice-recognition functions by software control programs. This circuit card 1406 may also contain the controlling program.

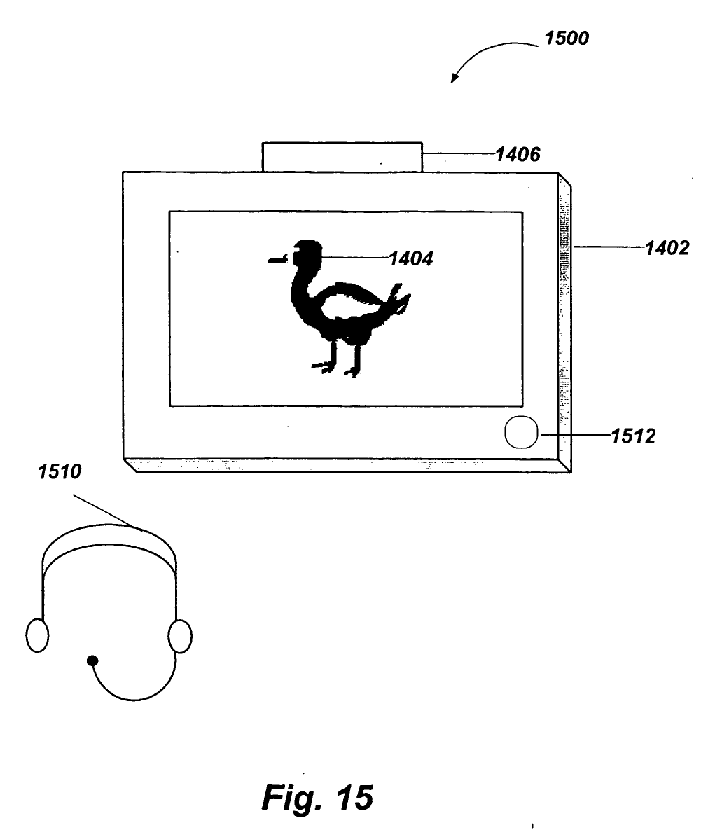

A hand-held device may also have a wireless input and output unit (FIG. 15). This may be implemented by having a wireless interface 1512 that communicates with a wireless device 1510, such as a wireless headset.

Virtual Audio Toy

In another embodiment of the invention, the teachable toy has no visual or tangible component but is primarily an interactive and audio toy (FIG. 17), which is spoken to and heard by way of voice and/or data telephony using a wired or wireless communication network. This virtual toy, similar to the embodiments above (FIGS. 1 and 13 through 15) may mimic any number of entities, e.g. babies, animals, cartoon characters, famous personalities, etc. They may, for example, be heard and interacted with through cellular telephones, and the like.

A virtual audio toy system 1700 may support a number of individual users, preferably by way of a public-switch telephone networking system. The virtual audio toy may also be communicated with via a data network 1004, e.g. the Internet (voice-over-IP).

The virtual audio toy of the present invention may be used for entertainment and instructive purposes. This system 1700, for example, may be offered as a paid entertainment game by subscription, or it could be offered by a sponsoring entity as a game show, with prizes awarded to players (users) who achieve the most words taught, the fastest learning rate, and the like.

With sufficiently powerful host computers (servers), running special AI software programs and possessing voice recognition and speech synthesis capabilities, and a connection to a voice telephonic network, the virtual audio toy of the present invention may learn how to speak target words and target sentences, and may even engage in realistic conversation with the users of this system 1700.

In general, a user of a virtual audio toy system 1700 (FIG. 17) communicates with a virtual audio toy via a phone 1702, 1706 or any telephonic audio device using a communication network 1706, 1708. A user preferably uses a phone 1702, 1704 to teach this virtual audio toy simulated speech learning and other applicable features discussed in the above embodiments of the invention. By calling a certain number, the user connects via the phone 1702, 1704 to a processing unit 1716 that implements the features described above. Wireless telephonic devices 1708 may also be used to connect to the public phone network 1706, e.g. via RF links 1708, which communicate with a cellular antenna 1730.

The user to be distinguished from other users typically also enters a unique or personal identification code, such as an extension number and a password or other information, either by pressing the touch-tone buttons and/or by voice commands (verbally saying the information or command). Each user thus has his or her own virtual audio toy(s), with each toy having its own learning level information.

This processing unit 1716, similar to the 3D teachable toy and the virtual AV toy, accepts inputs (e.g. target words to be learned) and returns outputs (e.g. protowords, metawords, target words, etc.). The processing unit 1716 may be embodied in a large mainframe computer, or in a bank of mini or microcomputers, or other powerful computing system. This way, a much more powerful and intelligent voice recognition and AI engine may be implemented, as compared to the ones implemented with a low-cost microcontroller 100 (FIG. 1).

This processing unit or system 1716 (FIG. 17) 1804, 1812 (FIG. 18) may also service and support a large number of users, including simultaneous users, by means of a very large capacity memory and data storage system 1806, 1818, 1810 (FIG. 18). Thousands or even millions of users may subscribe to this virtual audio system 1700 (FIG. 17) with each user generally having his or her own database of learning level information, implemented for example via a user database/files 1808 and a learning level database 1810 (FIG. 18). A user may thus call anytime and begin to play and teach his or her virtual audio toy, conclude teaching, and then call back at a later time to resume teaching where prior play or teaching was suspended.

A processing unit, particularly for a subscription service (“play and pay” service), if so desired, may also have a billing program 1724 that tracks billing and payment information for each user and/or sends billing charges to the users phone or communications system. This may be implemented, for example, by calling a “1-900” number.

To handle a large number of users, such virtual audio systems include a trunk line of multiple phone lines 1714 coming from a phone company branch office switch. A trunk multiplexer handles individual voice lines for each user/caller. These multiplexers also include A/D and D/A converters to process incoming analog voice input for digital data processing. A scaled-down version of the processing unit 1716 or system 1700 (FIG. 17) may also be implemented.

Considering the embodiments of the present invention (e.g. 3D teachable toy, virtual AV toy, and virtual audio toy) utilize existing speech synthesis technology and voice recognition technology, these embodiments may also utilize and be enhanced by future and emerging voice recognition and speech synthesis technologies and algorithms.

In general, the various embodiments of the teachable toy (3D 100 (FIG. 1), virtual AV toy (FIGS. 13 through 15), and the virtual audio toy (FIG. 18) are essentially defined by various algorithms implemented in stored controlling programs, particularly a controlling unit, e.g. of a microcontroller or a computer, in conjunction with memory devices and I/O channels.

Generally this controlling unit is written by programmers and stored into memory (ROM and/or RAM) depending if the controlling instructions are processed by a microprocessor or by a computer processor. The specific implementation of the controlling unit thus may vary depending on the processing unit used.

For example, if a computer is used, the controlling unit, as well as other software components (the various engines, voice synthesizers, voice recognizers, etc.), if applicable, may be written in various high-level programming languages such as Visual Basic, C++, or assembly language. A different set of programming languages, however, may be used to control and instruct microcontrollers.

An exemplary computer 1100 such as might comprise a computer or processing unit 1350 (FIG. 13), 1716 (FIG. 17) that supports virtual toys, enables the features described above, and enables various display, audio, and computer processing operations generally have several components. Each computer 1100 operates under the control of a central processor unit (CPU) 1902, such as a “Pentium” microprocessor and associated integrated circuit chips, available from Intel Corporation of Santa Clara, Calif., USA.

A computer user can enter input information and teach the virtual toys of the present invention via various input devices 1912, including microphones, keyboards, computer mouse, etc. Virtual AV toys, textual outputs, and various status indicators maybe viewed from a display 1910.

The display 1910 is typically a video monitor or flat panel display. The computer 1900 also includes a direct access storage device (DASD) 1904, such as a hard disk drive. The memory 1906 typically comprises volatile semiconductor RAM.

Each computer preferably includes a program product reader 1914 that accepts a program product storage device 1919, from which the program product reader can read data (and to which it can optionally write data). The program product reader 1914 can comprise, for example, a disk drive, and the program product storage device can comprise removable storage media such as a magnetic floppy disk, a CD-R disc, a CD-RW disc, or DVD disc.

The computer 1900 can communicate with other computers over a computer network 1916 (such as the Internet or an intranet) through a network interface 1908 that enables communication over a connection 1918 between the network 1916 and the computer 1900. The network interface 1908 typically comprises, for example, a network interface card (NIC) or a modem that permits communications over a variety of networks (e.g. wired, wireless, RF, optical, etc.).

The CPU 1902 operates under control of programming steps (typically part of the controlling unit) that are temporarily stored in the memory 1906 of the computer 1900. When the programming steps are executed (e.g. the AI engine 202, conversation engine 206, etc. (FIG. 2), the computer performs its functions.

Thus, the programming steps implement the functionality of the virtual toys and their systems described above. The programming steps can be received from the DASD 1904, through the program product storage device 1919, or through the network connection 1918.

The program product storage drive (reader) 1914 can receive a program product 1919, read programming steps recorded thereon, and transfer the programming steps into the memory 1904 for execution by the CPU 1902. As noted above, the program product storage device 1919 can comprise any one of multiple removable media having recorded computer-readable instructions, including magnetic floppy disks and CD-ROM storage discs.

Other suitable program product storage devices can include magnetic tape and semiconductor memory chips. In this way, the processing steps necessary for operation in accordance with the invention can be embodied on a program product.

Alternatively, the program steps can be received into the operating memory 1906 over the network 1916. In the network method, the computer 1900 receives data including program steps into the memory 1904 through the network interface 1908 after network communication has been established over the network connection by well-known methods that will be understood by those skilled in the art without further explanation. The program steps are then executed by the CPU 1902 thereby comprising a computer process.

Alternatively, the computer 1900 and maybe its components may have an alternative construction, so long as the alternative construction supports the functionality described herein.

The present invention has been described above in terms of a now-preferred embodiment so that an understanding of the invention can be conveyed. There are, however, many configurations for apparently teachable toys, not specifically described herein but to which the present invention is still applicable. The foregoing illustrates preferred embodiments of the invention by way of example, not by way of limitation.

For example, the ICs used to implement the features of the invention may have a different block diagram and circuitry than the ones discussed herein; and the operations to teach a teachable toy to simulate learning may have a different order, contain less or more operations, or have a different operations than those discussed herein, e.g. a teachable toy automatically learns a word if a special secret code is spoken or downloaded to the toy or teachable toy system.

The present invention should therefore not be seen as limited to the particular embodiments described herein, but rather should be understood to have wide applicability with respect to teachable toys and teachable toy systems. All modifications, variations, or equivalent arrangements and implementations that are within the scope of the attached claims should therefore be considered within the scope of the invention.

1. A children's play method for creating the appearance of teaching a toy character to progressively learn a language, said method comprising the steps of:
defining a target word;
receiving by the toy character the target word zero or more times over a first period of time defined by one or more predetermined criteria;
speaking and/or displaying by the toy character during the first time period of one or more protowords related to the toy character but not to the target word;
then receiving by the toy character the target word zero or more times over a second period of time defined by one or more predetermined criteria;
speaking and/or displaying by the toy character during the second time period of one or more metawords related to the target word, or a combination of one or more such protowords and one or more such metawords;
then receiving by the toy character the target word zero or more times over a third period of time defined by one or more predetermined criteria; and
speaking and/or displaying by the toy character during the third time period of one or more target words, or a combination of one or more target words and one or more such metawords, or a combination of one or more target words and one or more such protowords, or a combination of one or more target words and one or more such protowords and one or more such metawords.

2. The method of claim 1:
wherein said one or more predetermined criteria are based on passage of time, activity by a user, and/or one or more sensor readings.

3. The method of claim 1:
wherein the metawords are algorithmically determined.

4. The method of claim 1:
wherein a set of learning-level information related to the target word is stored into one or more memory devices.

5. The method of claim 4, further comprising the step of:
resetting the stored set of learning-level information to its original natural state of knowing only protowords.

6. The method of claim 4:
wherein the set of learning-level information is represented by a set of mathematical matrices.

7. The method of claim 1:
wherein the predetermined criteria defining the first period of time, the predetermined criteria defining the second period of time, and/or the predetermined criteria defining the third period of time are controlled by a learning-level switch indicating speed of learning.

8. The method of claim 1:
wherein the speaking and/or displaying step during the first period of time, the speaking and/or displaying step during the second period of time, and/or the speaking and/or displaying step during the third period of time includes translating the target word into a different language.

9. The method of claim 1:
wherein the toy character learns a new target word only after the target word has been fully learned.

10. A program product for use in a computer system that executes program steps recorded in one or more computer-readable media to perform a method of simulated speech learning by a toy character; said program product comprising:
one or more computer-readable media; and
a program of computer-readable instructions executable by the computer to perform a method, the program comprising one or more program components stored in said one or more computer-readable media, said method comprising the steps of:
providing a target word;
receiving by the toy character the target word zero or more times over a first period of time defined by one or more predetermined criteria;
speaking and/or displaying by the toy character during the first time period of one or more protowords related to the toy character but not to the target word;
then receiving by the toy character the target word zero or more times over a second period of time defined by one or more predetermined criteria;
speaking and/or displaying by the toy character during the second time period of one or more metawords related to the target word, or a combination of one or more such protowords and one or more such metawords;
then receiving by the toy character the target word zero or more times over a third period of time defined by one or more predetermined criteria; and
speaking and/or displaying by the toy character during the third time period of one or more target words, or a combination of one or more target words and one or more such metawords, or a combination of one or more target words and one or more such protowords, or a combination of one or more target words and one or more such protowords and one or more such metawords.

11. The program product of claim 10:
wherein at least one of the receiving steps includes receiving the target word at least once by the toy character.

12. The program product of claim 10:
wherein the method further comprises the step of updating a set of learning-level information related to the target word, including incrementing one or more counters indicating the number of times the toy character has received the target word.

13. The program product of claim 12:
wherein the updating step includes incrementing one or more counters indicating the number of times the target word has been used in speaking and/or displaying by the toy character.

14. The program product of claim 10:
Wherein at least one of the receiving steps by the toy character includes receiving the target word through one or more sensors.

15. The program product of claim 14:
wherein the one or more sensors include a radio frequency (RF) ID tag sensor.

16. A device for simulated speech learning by a toy character, said device comprising:
a central processing unit; and
a program memory that stores programming instructions that are executed by the central processing unit such that a method is performed; said method comprising the steps of:
providing a target word;
receiving by the toy character the target word zero or more times over a first period of time defined by one or more predetermined criteria;
speaking and/or displaying by the toy character during the first time period of one or more protowords related to the toy character but not to the target word;
then receiving by the toy character the target word zero or more times over a second period of time defined by one or more predetermined criteria;
speaking and/or displaying by the toy character during the second time period of one or more metawords related to the target word, or a combination of one or more such protowords and one or more such metawords;
then receiving by the toy character the target word zero or more times over a third period of time defined by one or more predetermined criteria; and
speaking and/or displaying by the toy character during the third time period of one or more target words, or a combination of one or more target words and one or more such metawords, or a combination of one or more target words and one or more such protowords, or a combination of one or more target words and one or more such protowords and one or more such metawords.

17. The device of claim 16:
wherein a set of learning-level information related to the target word is stored into one or more memory devices.

18. The device of claim 17:
wherein the set of learning-level information is represented by a set of mathematical matrices.

19. A play method for creating the appearance that a toy character is learning to speak, said method comprising the steps of:
providing the toy character with a target word;
providing the toy character with potential outputs including the following which are arranged in order from lower to higher level:
outputs that include one or more protowords related to the toy character but not to the target word;
outputs that include one or more metawords related to the target word; and
outputs that include one or more repetitions of the target word;
providing the toy character with potential learning levels that correspond to the potential output levels;
sequentially increasing and updating the learning level to an active one based on one or more predetermined criteria; and
providing active output from the toy character of one or more of the potential outputs based on the active learning level;
available output at any active learning level being only the potential output associated with that active learning level and any lower potential outputs, but not any higher potential outputs.

20. The method of claim 19:
wherein the increasing and updating step is affected by sensors.

21. A method of simulated progressive speech learning by a toy character, the method comprising the steps of:
storing a dictionary of words and/or sounds;
setting an initial learning-level information;
receiving a word, the word a target word found in the dictionary;
recognizing the received word;
retrieving the learning-level information for the received word; and
generating an output based on the retrieved learning-level information.

22. The method of claim 21, further comprising the step of:
receiving and recognizing additional one or more words.

23. The method of claim 22, further comprising the step of:
determining a concatenated output by concatenating one or more words and/or one or more sounds from the dictionary and/or from algorithmically determined words and/or sounds; the concatenated output having a relationship to the received and recognized additional one or more words.

24. A method for causing a toy character to appear to learn target speech; said method comprising the steps, both performed by the toy character, of:
speaking or displaying protospeech generally associated with the toy character, but generally not associated with the target speech; and
responding by first waiting for at least one predetermined event, and then speaking or displaying other speech that is generally along a progression from the protospeech toward the target speech.

25. The method of claim 24, wherein:
the progression is substantially not monotonic in advancing from the protospeech toward the target speech;
whereby the toy character appears to sometimes forget what has been previously learned.

26. The method of claim 25, wherein:
advancement along the progression is generally statistical.
